(19) United States
(12) Patent Application Publication
(10) Pub. No.: US 2020/0192992 A1
(43) Pub. Date: Jun. 18, 2020

(54) INFORMATION PROCESSING APPARATUS AND PULL-UP AND PULL-DOWN RESISTOR VERIFICATION METHOD

(71) Applicant: FUJITSU LIMITED, Kawasaki-shi (JP)

(72) Inventor: Yuji BABA, Kawasaki (JP)

(73) Assignee: FUJITSU LIMITED, Kawasaki-shi, (JP)

(21) Appl. No.: 16/682,228

(22) Filed: Nov. 13, 2019

(30) Foreign Application Priority Data
Dec. 14, 2018 (JP) 2018-234671

(51) Int. Cl. G06F 17/50

(52) U.S. Cl. CPC G06F 17/5022; G06F 17/5081

(57) ABSTRACT

A computer-readable non-transitory recording medium having stored therein a pull-up and pull-down resistor verification program that causes a computer to execute a procedure, the procedure includes reading first definition information to define that a first resistor of a first circuit is a pull-up resistor or a pull-down resistor and second definition information to define that a second resistor of a second circuit is a pull-up resistor or a pull-down resistor, comparing the first definition information and the second definition information, and generating an error message in a case where one of the first resistor and the second resistor is the pull-up resistor and the other one is the pull-down resistor.

### CROSS-REFERENCE TO RELATED APPLICATION

This application is based upon and claims the benefit of priority of the prior Japanese Patent Application No. 2018-234671, filed on Dec. 14, 2018, the entire contents of which are incorporated herein by reference.

### FIELD

The embodiments discussed herein are related to an information processing apparatus and a pull-up and pull-down resistor verification method.

### BACKGROUND

In recent years, in printed circuit boards (PCBs), it has been required to realize various functions in addition to the reduction in design cost and manufacturing cost.

In the circuit design of the printed circuit board, there has been known a technique of increasing error detection accuracy of an electrical check relating to an I/F voltage by specifying an output pin of a part, and changing calculation or acquisition of the interface (I/F) voltage of the output pin depending on the part characteristics or state.

Japanese Laid-open Patent Publication No. 2015-41112, Japanese Laid-open Patent Publication No. 2007-94506, and Japanese Laid-open Patent Publication No.3-9476 are examples of the related art.

### SUMMARY

According to an aspect of the embodiments, a computer-readable non-transitory recording medium having stored therein a pull-up and pull-down resistor verification program that causes a computer to execute a procedure, the procedure includes reading first definition information to define that a first resistor of a first circuit is a pull-up resistor or a pull-down resistor and second definition information to define that a second resistor of a second circuit is a pull-up resistor or a pull-down resistor, comparing the first definition information and the second definition information, and generating an error message in a case where one of the first resistor and the second resistor is the pull-up resistor and the other one is the pull-down resistor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams for illustrating an existing verification example in a circuit design of a printed circuit board;

FIG. 2 is a diagram for illustrating acquisition of definition information on an internal resistor;

FIG. 3 is a diagram illustrating a display example of a circuit diagram illustrating an error location;

FIGS. 4A to 4D are diagrams illustrating a display example of internal resistor;

FIG. 5 illustrates a configuration example of hardware of a circuit design apparatus;

FIG. 6 is a diagram illustrating a configuration example of a function according to this embodiment;

FIG. 7 is a diagram illustrating a configuration example of a table of a DRC information DB;

FIG. 8 is a diagram illustrating a configuration example of data of each table of the DRC information DB;

FIG. 9 is a diagram illustrating a configuration example of a table of a circuit DB;

FIG. 10 is a diagram illustrating an example of a circuit diagram managed by a circuit DB;

FIG. 11 is a diagram for illustrating a configuration example of a table in the circuit DB;

FIG. 12 is a diagram for illustrating a configuration example of data of each table of the circuit DB;

FIG. 13 is a diagram illustrating a configuration example of a table of a part library DB;

FIG. 14 is a diagram for illustrating a configuration example of data of each table of the part library DB;

FIG. 15 is a diagram illustrating a configuration example of a table of a PLD part DB;

FIG. 16 is a diagram for illustrating a configuration example of data of each table of the PLD part DB;

FIG. 17 is a diagram illustrating a configuration example of data of definition information imported into the PLD part DB;

FIG. 18 is a diagram illustrating a data example by importing into the PLD part DB;

FIG. 19 is a diagram illustrating an import processing sequence;

FIG. 20 is a flowchart for illustrating a generating process in an operation S105 of FIG. 19;

FIG. 21 is a diagram for illustrating an outline of a parameter setting process of a mix check by a DRC control unit;

FIG. 22 is a diagram for illustrating a path data construction process by a DRC processing unit;

FIG. 23 is a diagram for illustrating a determination process of a pin having an internal resistor by the DRC processing unit;

FIG. 24 is a flowchart for illustrating a tracing process by a DRC processing unit;

FIG. 25 is a flowchart for illustrating a coupling part tracing process in an operation S315 of FIG. 24;

FIG. 26 is a diagram illustrating an example of a circuit diagram;

FIG. 27 is a diagram illustrating a data example of the circuit DB based on the circuit diagram of FIG. 26;

FIG. 28 is a diagram illustrating a relationship between a value obtained by the tracing process and a variable;

FIG. 29 is a diagram for illustrating an outline of the mix check by the DRC processing unit;

FIG. 30 is a diagram illustrating a DRC definition example;

FIG. 31 is a flowchart for illustrating a verification process by the DRC processing unit;

FIG. 32 is a flowchart for illustrating an internal resistor presence and absence determination process by the DRC processing unit;

FIG. 33 is a flowchart for illustrating an external resistor presence and absence determination process by the DRC processing unit;

FIG. 34 is a flowchart for illustrating an external resistor presence and absence determination process by the DRC processing unit;

FIG. 35 is a flowchart for illustrating an error information acquisition process by the DRC processing unit;

FIG. 36 is a flowchart for illustrating a checking process by the DRC processing unit;

FIG. 37 is a diagram illustrating a data example of relating to PLD in the circuit diagram of FIG. 26;

FIG. 38 is a diagram illustrating a result example of the verification process performed based on the circuit diagram of FIG. 26;

FIG. 39 is a diagram for illustrating presence and absence of error detection by the verification process based on a design status;

FIG. 40 is a diagram illustrating a data example of a DRC information DB in a case where an error is detected;

FIG. 41 is a diagram illustrating a screen example displayed based on the data example of FIG. 40;

FIG. 42 is a diagram illustrating a screen example that is displayed in response to an operation for enabling display control;

FIGS. 43A and 43B are diagrams illustrating an example of a mixed pattern between external resistors classified into an error type A;

FIGS. 44A and 44B are diagrams illustrating an example of a mixed pattern between internal resistors classified into an error type B;

FIGS. 45A to 45F are diagrams illustrating an example of a mixed pattern between the internal resistor and the external resistor classified into an error type C;

FIGS. 46A and 46B are diagrams illustrating an example of the mixed pattern including a plurality of errors classified into an error type D;

FIG. 47 is a flowchart illustrating an error display process by a display processing unit; and

FIG. 48 is a flowchart for illustrating a link information creation process performed in operation S503 of FIG. 47.

### DESCRIPTION OF EMBODIMENTS

A circuit design of a printed circuit board (PCB) is performed by using a programmable logic device (PLD). Depending on the purpose and application, a complex programmable logic device (CPLD) or a field-programmable gate away (FPGA) is used as PLD.

The internal logic circuit and I/O settings of PLD may be controlled by the designer's program. Therefore, in a case where the PCB circuit using PLD is designed, it is required to design in consideration of a mutual influence between inside and outside of PLD. On the other hand, in the couple of the PLD and IC circuits, a pull-up resistor or a pull-down resistor is used to stabilize a circuit operation by increasing a signal speed.

However, the pull-up resistor or pull-down resistor may be designed inside each circuit. In this case, the signal may not be sufficiently stabilized by the pull-up resistor or the pull-down resistor designed in the couple of the circuits, and the IC may malfunction. In the circuit design of PCB, verification considering the pull-up resistor or pull-down resistor inside the circuit depends on the experience and skill of the verifier, so it is difficult to perform a sufficient verification work.

Hereinafter, an embodiment of a technique capable of checking the consistency between an internal resistor and an external resistor of a PLD during circuit design will be described with reference to the drawings. In the verification of the circuit design relating to the printed circuit board (PCB), a case where an error may not be detected properly by the verification based on the existing design rule check (DRC) will be described. A case where a programmable logic device (PLD) and an integrated circuit (IC) are coupled with each other will be described; however the embodiment is not limited to this case. The same applies to the relationships between IC-IC, PLD-PLD, and IC-PLD.

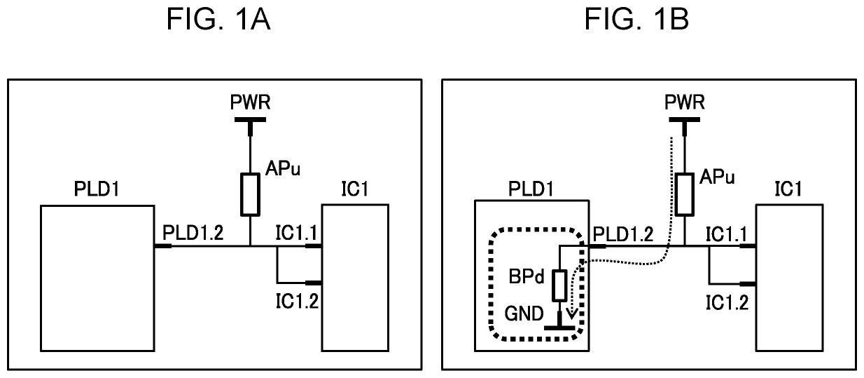

FIGS. 1A and 1B are diagrams for illustrating an existing verification example in a circuit design of a printed circuit board. FIG. 1A and FIG. 1B illustrate examples of circuit diagrams illustrating the arrangement and wiring of PLD1, IC1, and pull-up resistor Pu designed on the PCB. The PLD1 and the IC1 will be described as examples of parts arranged on the PCB; however, the embodiment is not limited to these circuits.

In this circuit diagram, an output pin PLD1.2 of the PLD1 is coupled with input pins IC1.1 and IC1.2 of the IC1. In order to stabilize signal propagation, a pull-up resistor APu is disposed and wired between a wiring that couples the PLD1 and the IC1 and a power supply PWR.

As illustrated in FIG. 1A, in the circuit diagram in which the PLD1, the IC1, and the pull-up resistor APu which are designed on the PCB are arranged and wired, neither the PLD1 nor the IC1 indicates any internal resistor, and thus no error is detected in the wiring between the PLD1 and the IC1 in the existing verification.

FIG. 1B illustrates an example in which a pull-down resistor BPd is disposed and wired to the output pin PLD1.2 in the PLD1. The pull-down resistor BPd is grounded with GND. In this circuit diagram, the current supplied from the power supply PWR is not supplied to the IC1, but is drawn into the output pin PLD1.2 by the pull-down resistor BPd in the PLD1, and flows to the GND. In a case where the internal resistor is taken into consideration in this way, an error may be detected regarding the wiring between the PLD1 and the IC1.

However, with an existing circuit design apparatus by a computer-aided design (CAD) or the like, since verification that considers the internal resistor of the PLD part has not been performed, in a case where the PLD part is used, the designer has designed and verified PCB while checking the internal resistor information of the PLD part.

Since such design and verification work depends on skills based on the verifier's knowledge and experience, verification accuracy may vary depending on the verifier, and the verification work may not be sufficiently accurate. In PLD internal design and PCB circuit design, in a case where the designers may be different and information sharing between the designers is not enough, there is a concern in that inappropriate is not able to be detected sufficiently, which leads to defects in a final product.

The embodiment described below provides a verification technique for a circuit design related to PCB which is capable of detecting a usage status of an internal resistor of the circuit and a deficiency in a design content relating thereto. With the verification technique according to this embodiment, it is possible to reduce the burden of reviewing design works of the designer of the circuit as a part and the designer of the PCB relating to the development of the PCB, and to reduce the burden of the verification work of the verifier of the designed PCB. This may reduce the occurrence of PCB defects in the post-process.

In this embodiment, at least the following items may be executed.
1. The presence or absence of an internal pull-up resistor or an internal pull-down resistor (hereinafter, sometimes simply referred to as “internal resistor”) may be defined for each pin of the circuit.
2. A mix check of the pull-up resistor and the pull-down resistor may be performed by identifying the definition of the above 1. and including the presence of the internal resistor for each wiring between the circuits.
3. In the mix check of the above 2., a user may designate the internal resistor to be checked for mixture from internal resistor information defined in the above 1.
4. In a case where an inappropriate coupling status is detected by the mix check of the above 2., error information is created and displayed so that the user may easily check an error location.
5. Information that allows the user to visually recognize the presence or absence of the internal resistor may be displayed on a circuit diagram by using the internal resistor information defined in the above 1.

In the above description, the user may be a designer of a circuit and a PCB as a part, a verifier of the designed PCB, or the like.

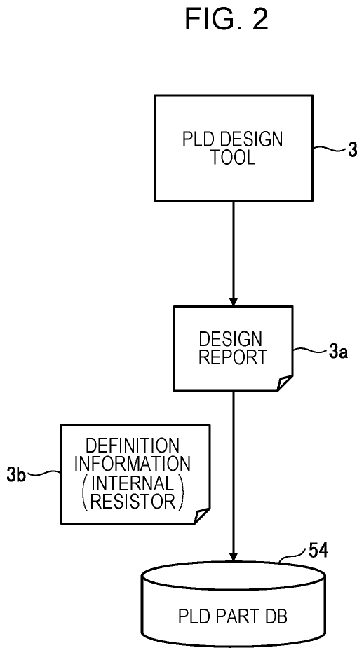

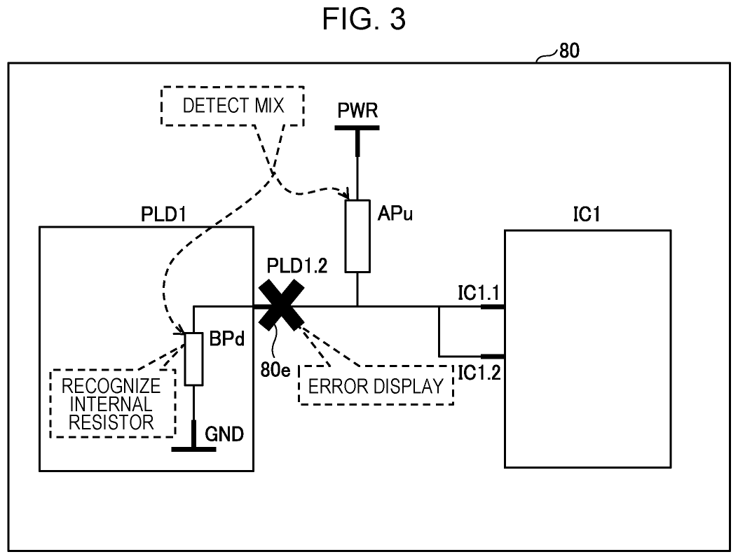

The outlines of the above 1. to 5. will be described with reference to FIGS. 2 and 3. FIG. 2 is a diagram for illustrating acquisition of definition information on the internal resistor. In FIG. 2, the user usually uses a PLD design tool 3 to design a PLD circuit. In the circuit design of the PLD, each PLD is designed to operate stably, and the user may include a pull-up resistor or a pull-down resistor in the circuit for the purpose of stabilizing the operation.

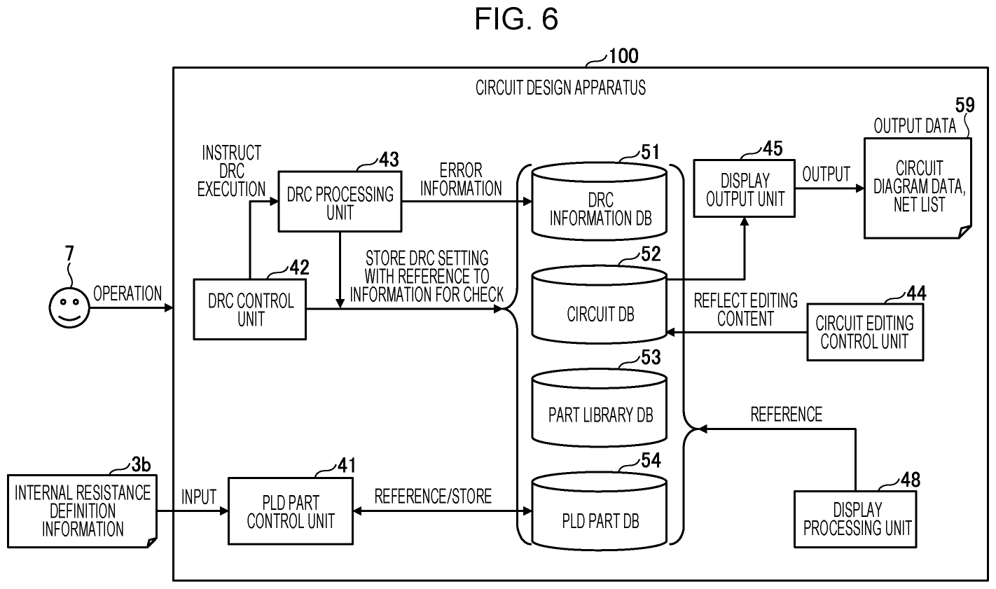

The PLD design tool 3 may output a design report 3a, and the design report 3a includes definition information 3b for each pin. In a case where the pin has the pull-up resistor or the pull-down resistor inside the PLD, the type of the internal resistor is indicated in the definition information 3b. Such definition information 3b is imported into a PLD part DB 54 corresponding to a PLD library. The PLD part DB 54 is held in a circuit design apparatus 100 (FIG. 6) described below. When the circuit design apparatus 100 performs the verification process according to this embodiment and detects an error, a circuit diagram indicating the error as illustrated in FIG. 3 is displayed.

FIG. 3 is a diagram illustrating a display example of a circuit diagram illustrating an error location. FIG. 3 illustrates a circuit diagram 80 in which the PLD1 and the IC1 are coupled in PCB design. In the circuit diagram 80, in the verification process according to this embodiment, the pull-down resistor BPd is recognized inside the PLD1 in addition to detecting the pull-up resistor APu for the couple of the PLD1 and the IC1. Therefore, it is detected that the pull-up resistor APu and the pull-down resistor BPd are mixed between the PLD1 and the IC1.

In this embodiment, in the PLD1, the recognized pull-down resistor BPd inside the PLD1 is displayed, and an error display 80e is added to the output pin PLD1.2 to which the pull-down resistor BPd is coupled so as to display the circuit diagram 80.

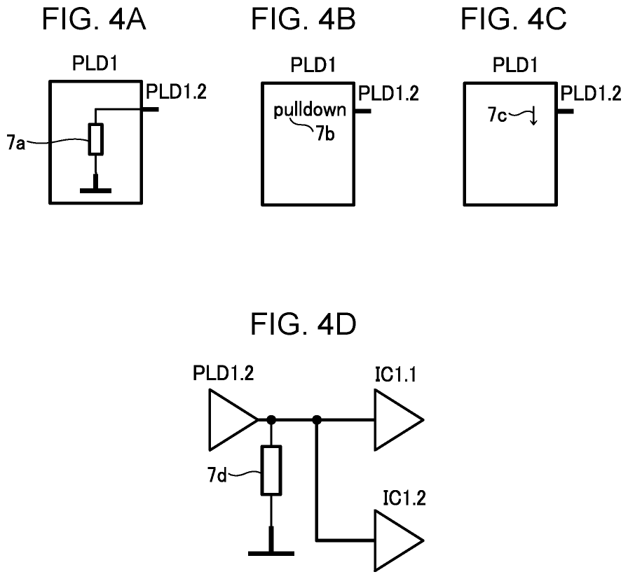

The display of the pull-up resistor or the pull-down resistor inside the part is not limited to the example of FIG. 3. Other display examples are illustrated in FIGS. 4A to 4D. FIGS. 4A to 4D are diagrams illustrating a display example of internal resistor. FIGS. 4A to 4C illustrate display examples of whether or not there is an internal resistor in the part symbol.

FIG. 4A is an example in which the presence of the internal resistor is indicated in a simplified circuit diagram 7a, as illustrated in FIG. 3. FIG. 4B is an example in which the type of internal resistor is indicated by a character 7b. FIG. 4C illustrates an example in which the type of internal resistor is indicated by a simple symbol 7c.

FIG. 4D is an example in which the internal resistor is indicated by a pseudo display 7d by a topology display function that abstracts and displays how parts, power supply, and ground are coupled with a logical net (may be simply referred to as a net). In addition to these, various displays are conceivable as long as the display is made so that the internal resistor (pull-up resistor or pull-down resistor) in the part is understood.

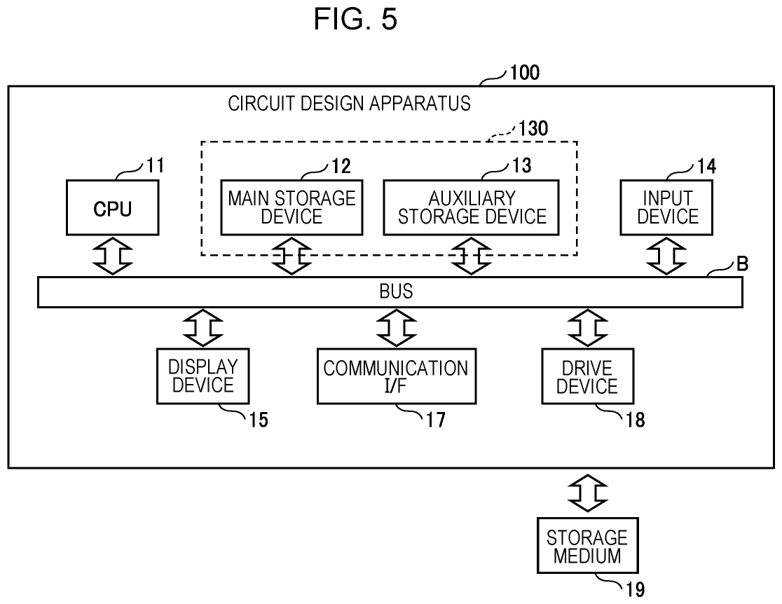

A circuit design apparatus 100 that realizes the above 1. to 5. according to this embodiment has, for example, a hardware configuration as illustrated in FIG. 5. FIG. 5 illustrates a configuration example of hardware of the circuit design apparatus.

According to FIG. 5, the circuit design apparatus 100 is an information processing apparatus, and includes a CPU 11, a main storage device 12, an auxiliary storage device 13, an input device 14, a display device 15, a communication I/F 17, and a drive device 18, which are coupled with a bus B. The auxiliary storage device 13, the input device 14, and an external storage device to which the circuit design apparatus 100 is accessible are collectively referred to as a storage unit 130.

The CPU 11 corresponds to a processor that controls the circuit design apparatus 100, and implements various processes according to this embodiment described below by executing a program stored in the storage unit 130.

The program according to this embodiment stored in a storage medium 19 (for example, a compact disc read-only memory (CD-ROM)) may be installed in the storage unit 130 via a drive device 18 to be executed by the CPU 11.

The storage medium 19 for storing the program according to this embodiment is not limited to the CD-ROM, and it may be any one or more non-transitory, tangible media having a computer readable structure. As a computer-readable storage medium, in addition to the CD-ROM, a digital versatile disk (DVD) disk, a portable recording medium such as a Universal Serial Bus (USB) memory, or a semiconductor memory such as a flash memory may be used.

FIG. 6 is a diagram illustrating a configuration example of a function according to this embodiment. In FIG. 6, the circuit design apparatus 100 includes a PLD part control unit 41, a DRC control unit 42, a DRC processing unit 43, a circuit editing control unit 44, a data output unit 45, and a display processing unit 48. The circuit design apparatus 100 holds a DRC information DB 51, a circuit DB 52, a part library DB 53, a PLD part DB 54, and an output data 59 to the storage unit 130. The PLD part control unit 41, the DRC control unit 42, the DRC processing unit 43, the circuit editing control unit 44, the data output unit 45, and the display processing unit 48 are functionally realized by the CPU 11 or the like in the circuit design apparatus 100.

The PLD part control unit 41 is a processing unit that allows a user 7 to edit information on parts such as a PLD used for PCB design. As one of the processes, when the user 7 inputs the definition information 3b of the internal resistor which is created by the user 7 using the PLD design tool 3, the PLD part control unit 41 imports the definition information into the PLD part DB 54. In the PLD part control unit 41, the definition information 3b may be input via a network, or may be held in the storage unit 130 in the circuit design apparatus 100.

The DRC control unit 42 sets setting information such as parameters at the time of DRC execution as the DRC information DB 51 according to the operation of the user 7. The DRC control unit 42 instructs the DRC processing unit 43 to execute DRC (verification process) according to the operation of the user 7.

In response to the DRC execution instruction from the DRC control unit 42, the DRC processing unit 43 executes the DRC based on the setting information stored in the DRC information DB 51, and in a case where an error is detected by the execution, error information 43e is stored in the DRC information DB 51.

The circuit editing control unit 44 displays a user interface for circuit design on the display device 15 according to the operation of the user 7, and supports the circuit design of the PCB. The information on the circuits constituting the PCB is stored in the circuit DB 52.

The data output unit 45 acquires circuit diagram data and a net list from the circuit DB 52 in accordance with the operation of the user 7, and outputs and holds the data as output data 59 to the storage unit 130. The display processing unit 48 controls the display device 15 to display the verification result by the DRC with reference to the databases 51 to 54.

The DRC information DB 51 is a database that stores a DRC check parameter, a verification result, and the like designated by the user 7. The circuit DB 52 is a database that stores circuit information input by the user 7. The part library DB 53 is a database for storing part definition information for PCB design. The PLD part DB 54 is a database that stores various pieces of definition information relating to the PLD part. Next, examples configurations of tables of these databases 51 to 54 will be described.

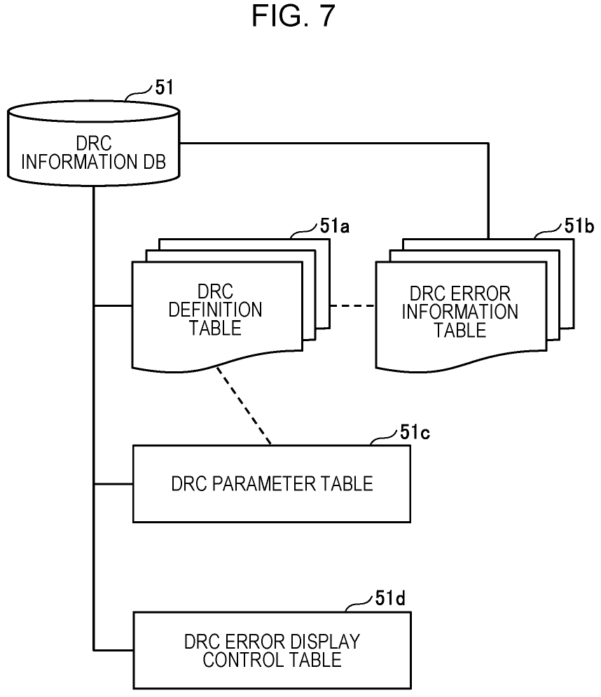

FIG. 7 is a diagram illustrating a configuration example of a table of a DRC information DB. According to FIG. 7, the DRC information DB 51 includes a DRC definition table 51a, a DRC error information table 51b, a DRC parameter table 51c, and a DRC error display control table 51d.

The DRC definition table 51a is a table that manages an error level, a check parameter, and the like of DRC checks. A table is created for each type of error detected by the check. The DRC error information table 51b is a table for managing error information detected by the DRC.

The DRC parameter table 51c is a table for managing a control parameter when the verification is performed by the DRC. The DRC error display control table 51d is a table for managing a display method when displaying DRC error information on the display device 15. The DRC error display control table 51d is updated according to the change by the user 7.

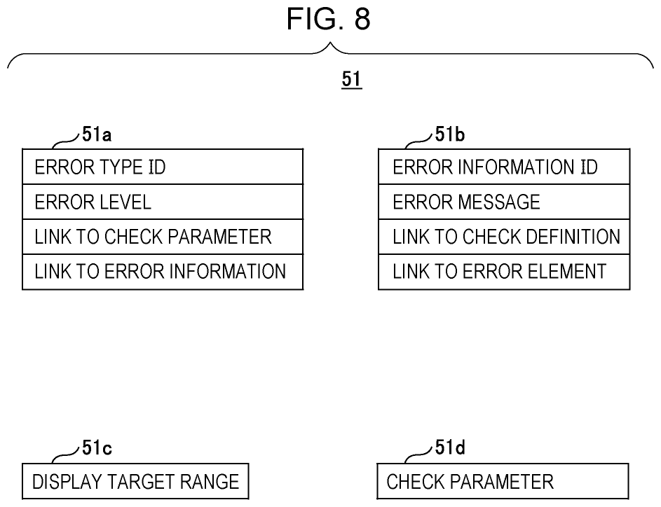

FIG. 8 is a diagram illustrating a configuration example of data of each table of the DRC information DB. According to FIG. 8, the DRC definition table 51a incudes items such as an error type ID, an error level, a link to the check parameter, and a link to the error information 43e.

The error type ID is identification information for specifying the error type, and uniquely specifies the error type in the DRC information DB 51. The error level indicates the importance of the error and is referred to as a parameter value by the display processing unit 48. The link to the check parameter indicates a link to the check parameter referred to by the DRC processing unit 43 at the time of verification. The link to the error information indicates a link to the error information 43e generated in each verification.

The DRC error information table 51b includes items such as an error information ID, an error message, a link to check definition, and a link to an error element. The error information ID is identification information for identifying error information, and uniquely specifies the error information 43e in the DRC information DB 51. The error message indicates a message explaining details of the error content. The link to the check definition indicates a link to the check definition that is a generation source of the error information 43e. The link to the error element indicates a link to the element (part pin) that has detected the error.

The DRC error display control table 51d includes a display object range and the like. The display object range indicates control information at the time of displaying the error information 43e on the display device 15. As the control information, information for filtering an error level to be displayed, information for filtering an error type to be displayed, and the like are designated.

The DRC parameter table 51c includes an item such as a check parameter. The check parameter indicates a parameter for controlling a check rule, and specific information is designated for each check. The check parameter is referred to by the DRC processing unit 43 at the time of checking. In this embodiment, the identifier of the internal resistor is designated by the check parameter. The identifier of the internal resistor may be indicated by a character string.

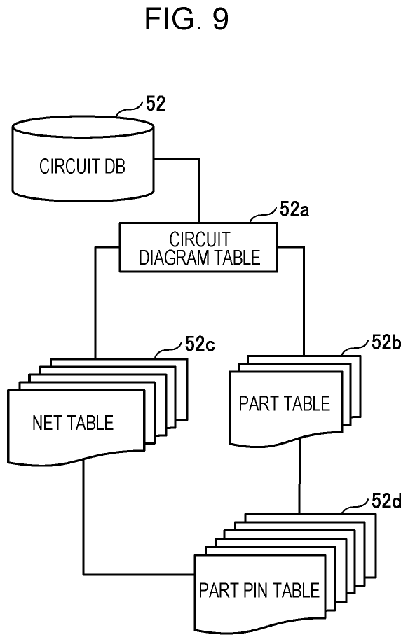

FIG. 9 is a diagram illustrating a configuration example of a table of a circuit DB. According to FIG. 9, the circuit DB 52 includes one or more circuit diagram tables 52a. One circuit diagram table 52a is created for one circuit diagram, and is managed by the circuit DB 52.

The circuit diagram table 52a is a table for managing the information on the entire circuit diagram, and holds links to a plurality of part tables 52b and a plurality of net tables 52c. The definition information of the internal resistor of the PLD part is also managed by the circuit diagram table 52a.

The part table 52b is a data table for managing information on the part included in the circuit diagram. When the part is added to the circuit diagram of the PCB by a user 7 such as a designer, one part table 52b is newly added to the storage unit 130, and a link to the part table 52b is added to the circuit diagram table 52a. The part table 52b holds a link to each of the plurality of part pin tables 52d.

The part pin table 52d is a data table for managing information on a plurality of part pins included in each part. The part pin table 52d holds a link to the master part table 52b. One part pin does not belong to a plurality of master parts. The number of part pins of the master part is defined in the part library and may not be changed by the user 7 at the circuit design stage. When a part is added to the circuit diagram, part pin tables for the number of pins that the part has are automatically created.

The net table 52c is a data table for managing net information included in the circuit diagram. When a net is added to the circuit diagram by the user 7, one net table 52c is added. A link to the coupling part pin table 52d is held.

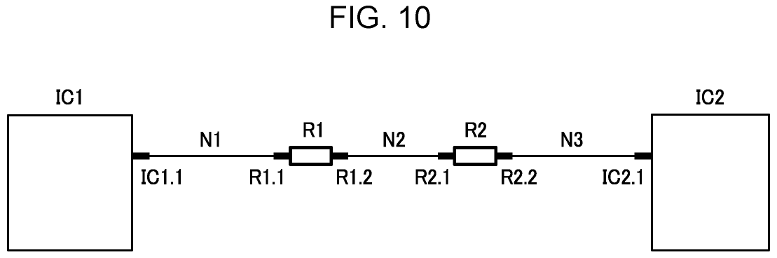

FIG. 10 is a diagram illustrating an example of a circuit diagram managed by the circuit DB. The circuit diagram illustrated in FIG. 10 will be described in a case where the parts IC1 and IC2 are coupled with each other. The part IC1 includes a part pin IC1.1. The part IC2 includes a part pin IC2.1. Parts R1 and R2 are arranged between the part IC1 and the part IC2 which are coupled with each other.

The part pin IC1.1 of the part IC1 is coupled with the part R1 by a net N1. The part R1 is coupled with the part R2 by a net N2, and the part R2 is coupled with the part pin IC2.1 of the part IC2 by a net N3.

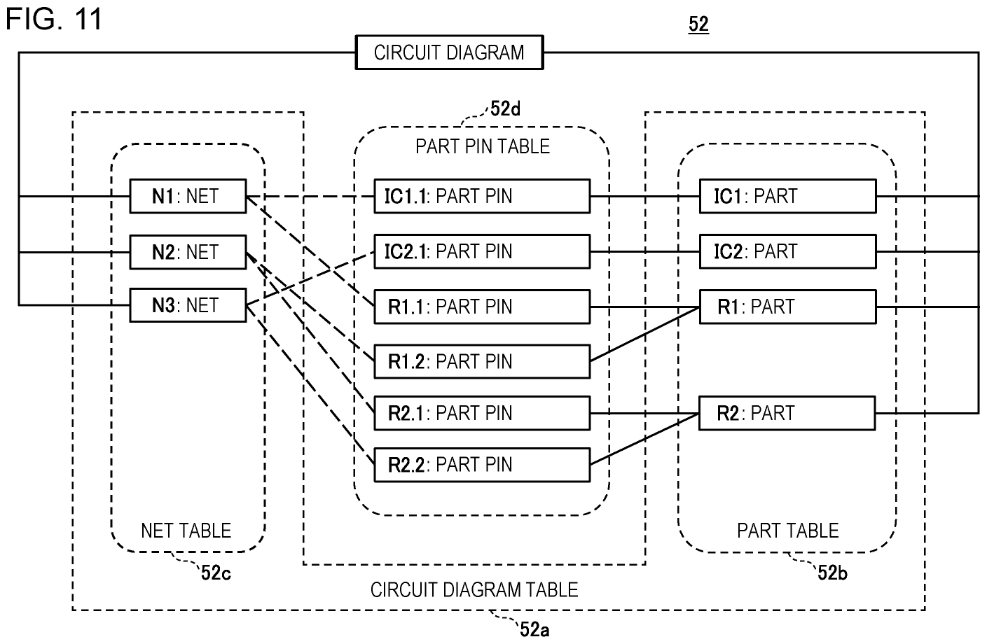

A configuration example of a table in the circuit DB 52 that manages the circuit diagram designed in this way will be described with reference to FIG. 11. FIG. 11 is a diagram for illustrating a configuration example of a table in the circuit DB.

According to FIG. 11, in the circuit diagram illustrated in FIG. 10, in the circuit DB 52, the information on the part IC1, the part IC2, the part R1, and the part R2 is held by the part table 52b. The information on the net N1, the net N2, and the net N3 is held by the net table 52c. The information on the part pin IC1.1, the part pin IC2.1, the part pin R1.1, the part pin R1.2, the part pin R2.1, and the part pin R2.2 is held by the part pin table 52d.

In the part table 52b, the information on the part IC1 includes a link to the part pin IC1.1, and the information on the part IC2 includes a link to the part pin IC2.1. The information on the part R1 includes a link to the part pin R1.1 and a link to the part pin R1.2. Similarly, the information on the part R2 includes a link to the part pin R2.1 and a link to the part pin R2.2.

In the part pin table 52d, the information on the part pin IC1.1 includes a link to the net N1, and the information on the part pin IC2.1 includes a link to the net N3. The information on the part pin R1.1 includes a link to the net N1, and the information on the part pin R1.2 includes a link to the net N2. The information on the part pin R2.1 includes a link to the net N2, and the information on the part pin R2.2 includes a link to the net N3.

On the other hand, the circuit diagram table 52a includes a link to the part IC1, a link to the part IC2, a link to the part R1, and a link to the part R2, which are managed by the part table 52b. The circuit diagram table 52a includes a link to the net N1, a link to the net N2, and a link to the net N3, which are managed by the net table 52c.

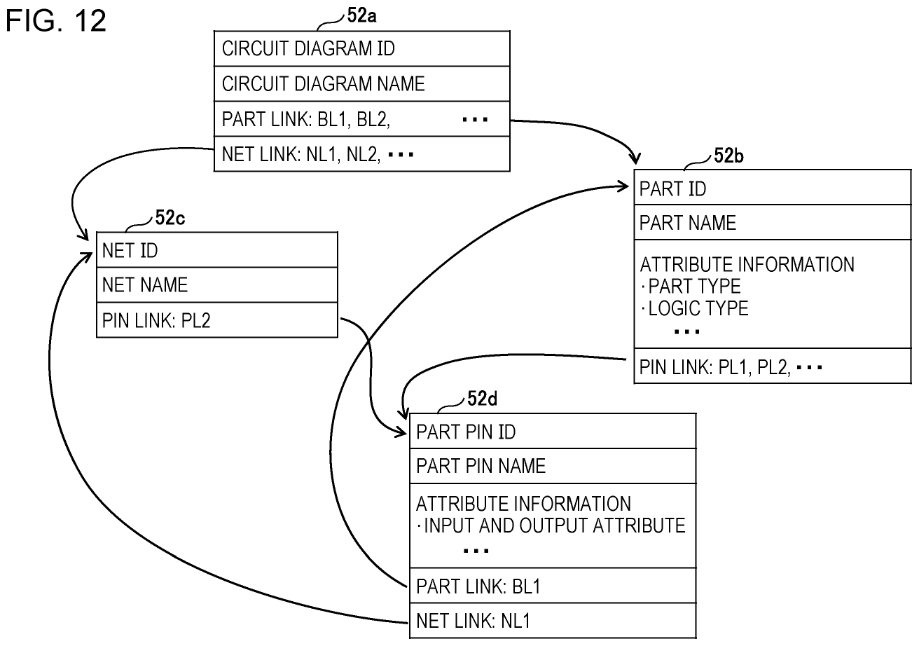

Next, configuration examples of data of the part table 52b, the net table 52c, and the part pin table 52d, which manage the information of each part. FIG. 12 is a diagram for illustrating a configuration example of data of each table of the circuit DB.

According to FIG. 12, the circuit diagram table 52a includes items such as a circuit diagram ID, a circuit diagram name, a part link, and a net link. The circuit diagram ID indicates identification information specifying a circuit diagram. The circuit diagram name indicates a name of the circuit diagram, and the name may be an automatically generated name or a name set by the user 7.

The part link indicates a link to information on a part included in the circuit, and usually indicates a link to information on a plurality of different parts. In this example, BL1, BL2, and the like are set as the part links, and each of BL1, BL2, and the like may indicate a start address, a part ID, and the like of the part table 52b in the storage unit 130.

The net link indicates a link to information on a net that couples parts, and usually indicates a link to information on a plurality of different nets. In this example, NL1, NL2, and the like are set as the net links, and each of NL1, NL2, and the like may indicate a start address, a net ID, and the like of the net table 52c in the storage unit 130.

The part table 52b includes items such as a part ID, a part name, attribute information, and a pin link. The part ID indicates identification information that uniquely specifies the part in the circuit DB 52. The part name indicates a name of the part, and the name may be an automatically generated name or a name set by the user 7.

The attribute information includes various pieces of information relating to the characteristics of the part, and includes, for example, information such as a part type, a logical type, a detailed classification, a library access key, and logical transparency. The part type indicates any of IC, R as the resistor, and the like. The logic type indicates any of a pull-up resistor, a pull-down resistor, a capacitor, a transistor, and the like. The detailed classification indicates any of a field-programmable gate away (FPGA), a complex programmable logic device (CPLD), and a ball grid array (BGA). The library access key indicates a key specifying a part library. The logical transparency indicates true or false.

The pin link indicates a link to information for each pin of the part. In this example, PL1, PL2, and the like are set as pin links, and each of PL1, PL2, and the like may indicate a start address, a part pin ID, and the like of the part pin table 52d in the storage unit 130.

The net table 52c includes items such as a net ID, a net name, and a pin link. The net ID indicates identification information that uniquely specifies the net in the circuit DB 52. The net name indicates a name of the net, and the name may be an automatically generated name or a name set by the user 7. The pin link indicates a link to information on a coupling destination net. In this example, PL2 is set as a pin link, and the PL2 may indicate the start address, the part pin ID, and the like of the part pin table 52d in the storage unit 130.

The part pin table 52d includes items such as a part pin ID, a part pin name, attribute information, a part link, and a net link. The part pin ID indicates identification information that uniquely specifies the part pin in the circuit DB 52. The part pin name indicates a name of the part pin, and the name may be an automatically generated name or a name set by the user 7.

The attribute information includes information relating to the characteristics of the part pin, and includes, for example, an input and output attribute. In a case where the part pin is an input pin, the input and output attribute indicates “input”, in a case where the part pin is an output pin, it indicates “output”, and in a case where the part pin is an input and output pin, it indicates “input and output”. The input and output attribute is not set for a logically transparent part (described later) such as a resistor.

The part link indicates a link to the part table 52b that manages information on the part to which the part pin belongs. In this example, BL1 is set as the part link, and the BL1 may indicate the start address, the part ID, and the like of the part table 52b in the storage unit 130. The net link indicates a link to the net table 52c that manages information on the net with which the part pin is coupled. In this example, NL1 is set as the net link, and the NL1 may indicate the start address, the part ID, and the like of the net table 52c in the storage unit 130.

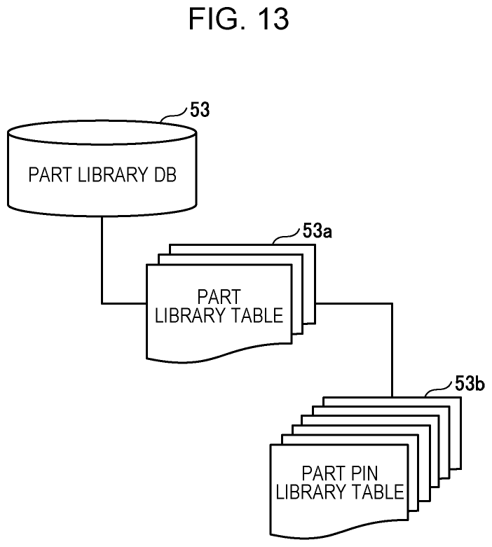

FIG. 13 is a diagram illustrating a configuration example of a table of a part library DB. According to FIG. 13, the part library DB 53 includes a part library table 53a and a part pin library table 53b.

The part library table 53a is a table for managing various pieces of definition information on the part, and holds links to one or more part pin library tables 53b. One record of the part library table 53a corresponds to a library of one part (part library).

The part pin library table 53b is a table for managing the various pieces of definition information on the part pin. One part library table 53a is linked to a plurality of the part pin library tables 53b. One record of the part pin library table 53b corresponds to a one part pin library (part pin library).

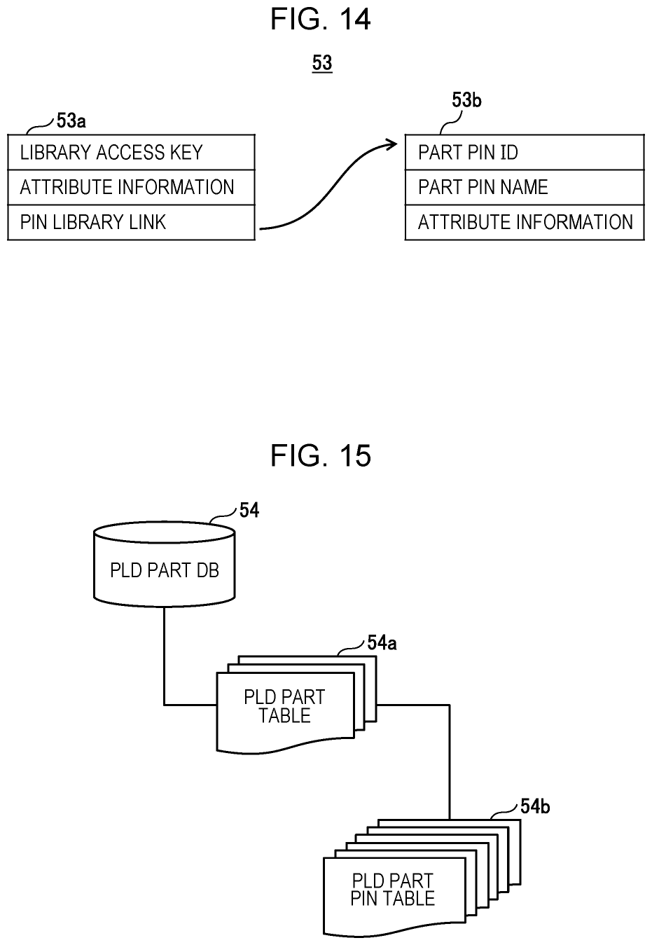

FIG. 14 is a diagram for illustrating a configuration example of data of each table of the part library DB. According to FIG. 14, the part library table 53a includes items such as a library access key, attribute information, and a part pin library link. The library access key indicates a character string used as a key for specifying a part library. A unique key is assigned to each part library.

The attribute information indicates definition information related to the feature of the part, and includes information such as a part type and a detailed classification. For the part type, any of IC, R as the resistor and the like is designated. For the detailed classification, one of FPGA, CPLD, BGA, and the like is designated. The part pin library link indicates a link to the part pin library associated with the part library. As the part pin library link, an address or a part pin ID of the part pin library table 53b in the storage unit 130 may be designated.

The part pin library table 53b includes items such as a part pin ID, a part pin name, and attribute information. The part pin ID indicates identification information that uniquely specifies the part pin library table 53b. The part pin name indicates a name of the part pin, and the name may be an automatically generated name or a name set by the user 7.

The attribute information includes information relating to the characteristics of the part pin, and indicates at least the input/output classification. In a case where the part pin is an input pin, the input and output attribute indicates “In”, in a case where the part pin is an output pin, it indicates “Out”, and in a case where the part pin is an input and output pin, it indicates “InOut”.

FIG. 15 is a diagram illustrating a configuration example of a table of a PLD part DB. According to FIG. 15, the PLD part DB 54 includes a PLD part table 54a and a PLD part pin table 54b.

The PLD part table 54a is a table for managing the various pieces of definition information on the PLD part. The PLD part table 54a is created for each library of parts used as a PLD, and holds links to a plurality of the PLD part pin tables 54b. The PLD part pin table 54b is a table for managing information on each of a plurality of pins of the PLD part. The PLD part pin table 54b is created for each part pin, and information relating to the pins of the PLD part is managed.

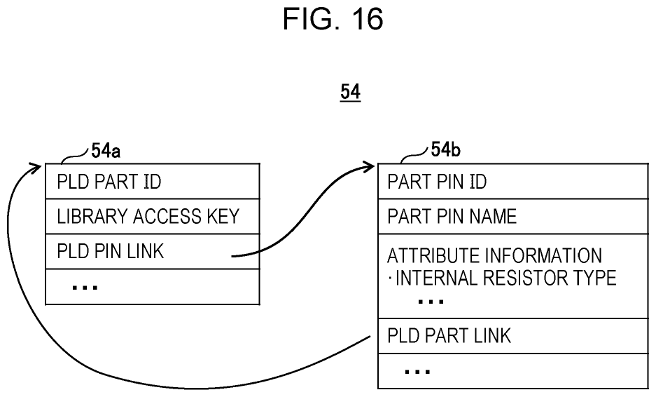

FIG. 16 is a diagram for illustrating a configuration example of data of each table of the PLD part DB. According to FIG. 16, the PLD part table 54a includes items such as a PLD part ID, a library access key, and a PLD pin link. The library access key indicates a character string used as a key for specifying a part library of a part used as a PLD part. The PLD pin link indicates a link to the PLD part pin table 54b for each PLD part pin. As the PLD pin link, the start address of the PLD part pin table 54b for the part pin in the storage unit 130 may be designated.

The PLD part pin table 54b includes items such as a part pin ID, a part pin name, attribute information, and a PLD part link. The part pin ID indicates identification information that uniquely specifies the PLD part pin in the PLD part DB 54. The part pin name indicates a name of the PLD part pin, and the name may be an automatically generated name or a name set by the user 7.

The attribute information includes information relating to the characteristics of the PLD part pin, and indicates an internal resistor of the PLD part pin. As an example, in a case where the pull-up resistor is coupled as the internal resistor, “Pullup” is indicated as an internal resistor type. In a case where the pull-down resistor is coupled as the internal resistor, “Pulldown” is indicated as an internal resistor type.

The PLD part link indicates a link of the PLD part to which the PLD part pin belongs to the PLD part table 54a. As the PLD part link, the start address of the PLD part table 54a in the storage unit 130 may be designated.

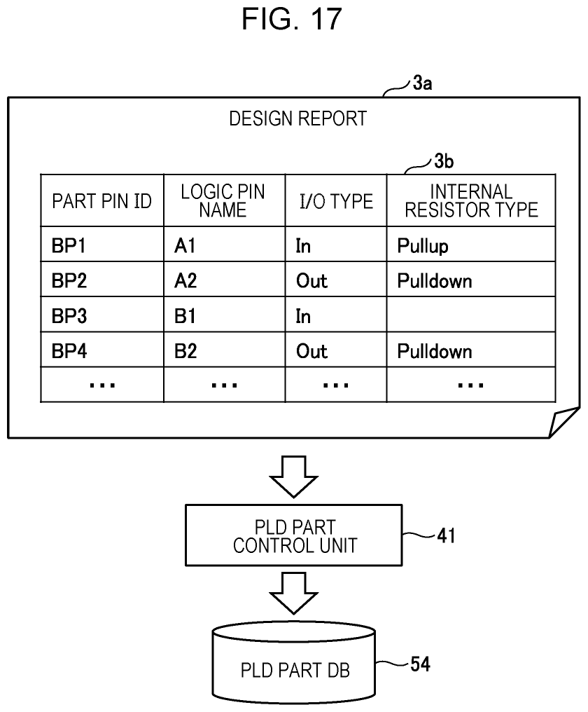

FIG. 17 is a diagram illustrating a configuration example of data of definition information imported into the PLD part DB. According to FIG. 17, the definition information 3b is included in the design report 3a output from the PLD design tool 3 (FIG. 2).

As an example of definition information 3b including the type of internal resistor, the definition information 3b includes items such as a part pin ID, a logic pin name, an I/O type, and an internal resistor type. The definition information 3b illustrated in FIG. 17 indicates only items required for the description of this embodiment, and the others are not illustrated.

The part pin ID indicates identification information that uniquely specifies the pin of the PLD part in the circuit DB 52. The logic pin name corresponds to the part pin name of the PLD part DB 54, and may be optionally set by the user 7, or may be a name automatically created.

The I/O type indicates a pin attribute. In a case of the input pin, the input and output attribute indicates “In”, in a case of the output pin, it indicates “Out”, and in a case of the input and output pin, it indicates “InOut”.

The internal resistor type indicates the type of internal resistor of the pin in the PLD part. In a case of the pull-up resistor, the internal resistor type indicates Pullup, and in a case of the pull-down resistor, the internal resistor type indicates Pulldown.

When importing such definition information 3b, an access key for identifying the part library is assigned by the PLD part control unit 41 to import the definition information into the PLD part DB 54.

In this example, the internal resistor type is set in the definition information 3b, but the user 7 may set the internal resistor type via the PLD part control unit 41 after importing the definition information 3b. The PLD part control unit 41 may also designate the PLD part that reflects the internal resistor of the PLD part when the PCB is verified by the user 7 after the import. A data example of the PLD part DB 54 after import will be described using the data example of the definition information 3b in FIG. 17.

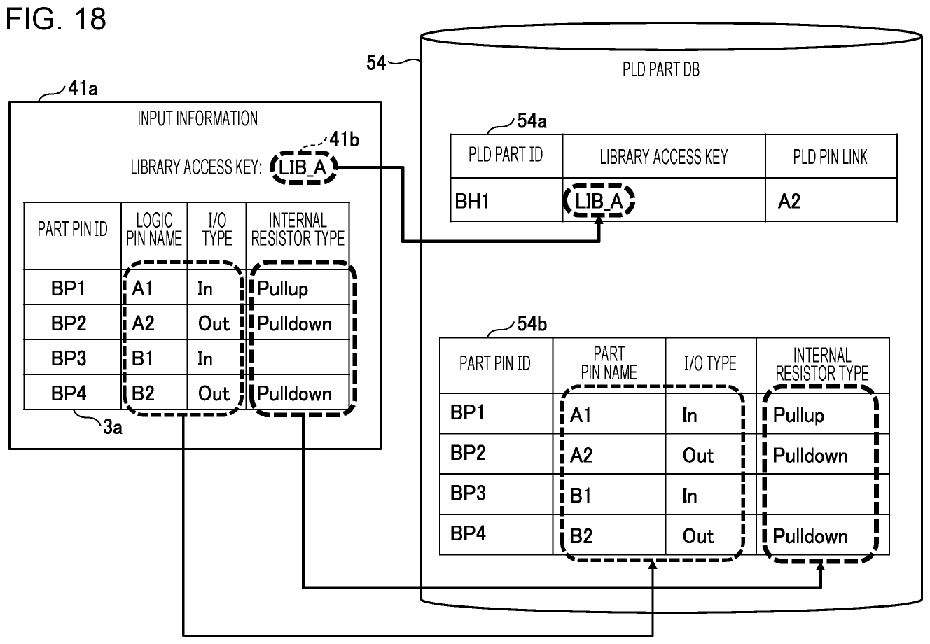

FIG. 18 is a diagram illustrating a data example by importing into the PLD part DB. According to FIG. 18, based on the input information 41a including at least a library access key 41b and the definition information 3b, the data is imported into the PLD part DB 54.

The PLD part control unit 41 imports the definition information 3a to the PLD part pin table 54b by using the library access key 41b designated by the input information 41a. In the definition information 3a, the logic pin name, the I/O type, the internal resistor type, and the like are stored to the part pin name, the I/O type, and the internal resistor type of the record that matches the part pin ID of the PLD part pin table 54b. In this example, among the records in the PLD part pin table 54b, information corresponding to the part pin IDs “BP1” to “BP4” is set as the record that matches with the part pin IDs “BP1” to “BP4” of the definition information 3a.

At the time of import, the PLD part control unit 41 checks the consistency between the part pin ID of the definition information 3a and the part pin ID of the PLD part pin table 54b. In other words, the import is performed only for the part pin ID existing in the PLD part pin table 54b, and the import is not performed for the part pin ID that does not exist.

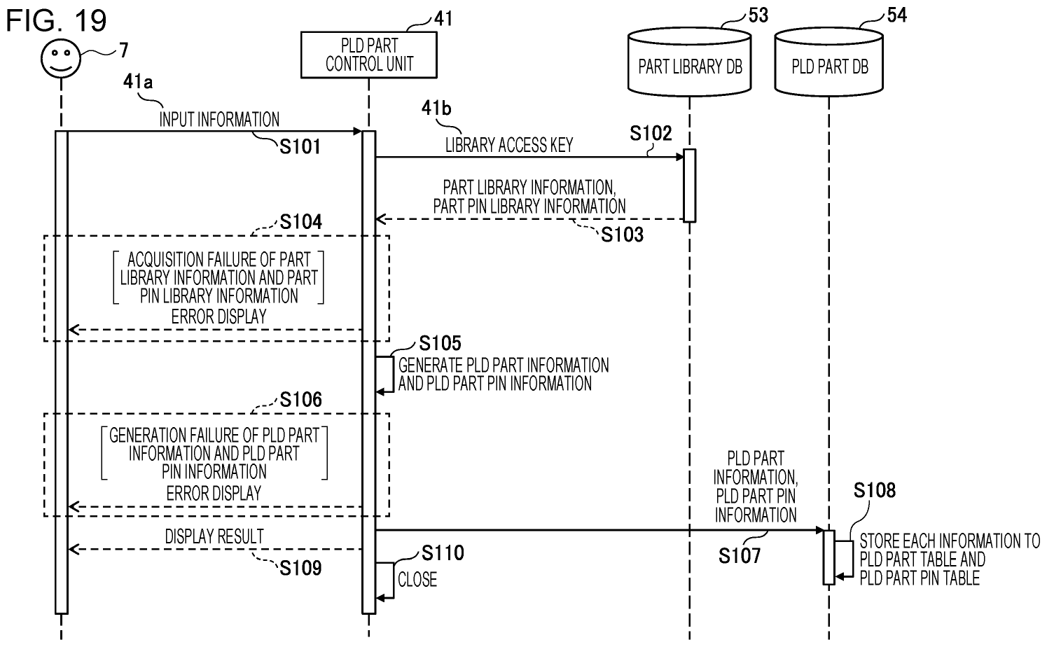

FIG. 19 is a diagram illustrating an import processing sequence. In FIG. 19, when the PLD part control unit 41 acquires the input information 41a from the user 7 (operation S101), the PLD part control unit 41 accesses the part library DB 53 using the library access key 41b (operation S102), and acquires part library information and part pin library information from the part library DB 53 (operation S103).

In a case where the PLD part control unit 41 fails to acquire the part library information and the part pin library information, an error display is displayed on the display device 15 (operation S104). On the other hand, in a case where the acquisition of the part library information and the part pin library information is successful, the PLD part control unit 41 generates the PLD part information and the PLD part pin information in the storage unit 130 based on the definition information 3a included in the input information 41a and the acquired part library information and part pin library information (operation S105).

In a case where the PLD part control unit 41 fails to generate the PLD part information and the PLD part pin information, an error display is displayed on the display device 15 (operation S106). On the other hand, in a case where the PLD part information and the PLD part pin information are successfully generated, the PLD part control unit 41 stores the generated PLD part information and the PLD part pin information in the PLD part table 54a and the PLD part pin table 54b (operation S108).

The PLD part control unit 41 displays the result on the display device 15 (operation S109), and ends a PLD part control process by the PLD part control unit 41 (operation S110).

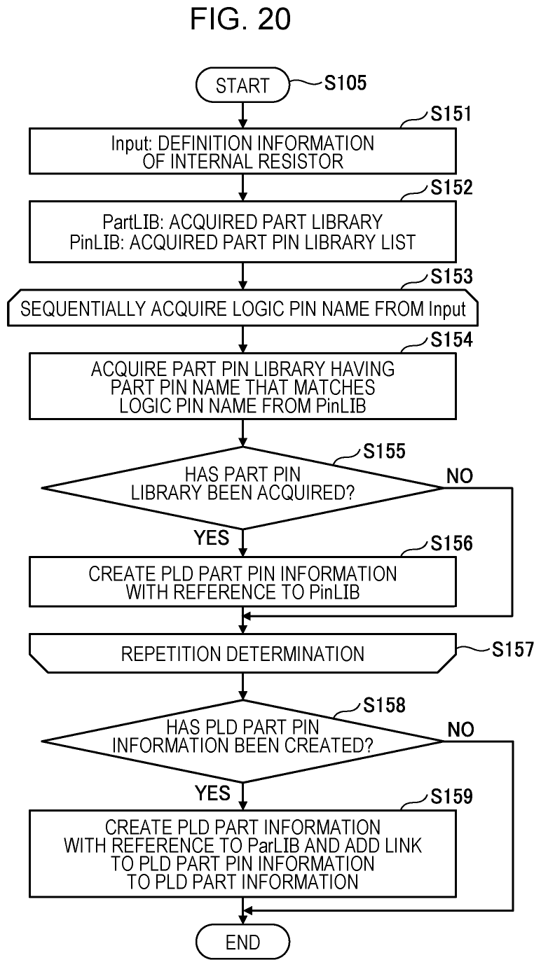

FIG. 20 is a flowchart for illustrating a generating process in an operation 5105 of FIG. 19. In FIG. 20, the PLD part control unit 41 holds the input information 41a acquired in the operation 5101 of FIG. 19 in a region Input of the storage unit 130 (operation S151). The region Input is, hereinafter, called Input, and is referred to acquire the internal resistor type in this generation process.

The PLD part control unit 41 holds the part library information and the part pin library information acquired in operation S103 of FIG. 19 in the region PartLIB and the region PinLIB of the storage unit 130, respectively (operation S152). The part library information acquired from the part library DB 53 is stored in the region PartLIB. Hereinafter, it is simply called “PartLIB”, and is referred to as a part library in this generation process. The part pin library information acquired from the part library DB 53 is stored in the region PinLIB. Hereinafter, it is simply called “PinLIB”, and is referred to as a part pin library in this generation process.

The PLD part control unit 41 sequentially acquires the logic pin names from Input until the PLD part pin information is created for all the logic pin names of Input (operation S153). Every time the logic pin name is acquired, operations S154 to S157 described below are repeated.

The PLD part control unit 41 acquires a part pin library having a part pin name that matches the logic pin name from the PinLIB (operation S154). The PLD part control unit 41 determines whether or not the part pin library has been acquired (operation S155). In a case where the part pin library is not able to be acquired (NO in operation S155), the PLD part control unit 41 proceeds to an operation S157. On the other hand, in a case where the part pin library is able to be acquired (YES in operation S155), the PLD part control unit 41 creates the PLD part pin information in the storage unit 130 with reference to PinLIB (operation S156), and proceeds to the operation S157. The PLD part pin information is stored in the storage unit 130.

The PLD part control unit 41 determines whether or not an unprocessed logic pin name exists in Input (operation S157). In a case where the unprocessed logic pin name exists, the PLD part control unit 41 returns to the operation S153, and the same processing is repeated; whereas in a case where the unprocessed logic pin name does not exist, the PLD part control unit 41 proceeds to an operation S158.

The PLD part control unit 41 determines whether or not the PLD part pin information has been created (operation S158). In a case where the PLD part pin information has not been created (NO in operation S158), the PLD part control unit 41 ends this PLD part control process. In a case where the PLD part pin information has been created (YES in operation S158), the PLD part control unit 41 creates the PLD part information in the storage unit 130 with reference to ParLIB, and adds a link to the PLD part pin information to the PLD part information (operation S159). It is desirable to add a link to the master PLD part information to each PLD part pin information. Thereafter, the PLD part control unit 41 ends the generating process.

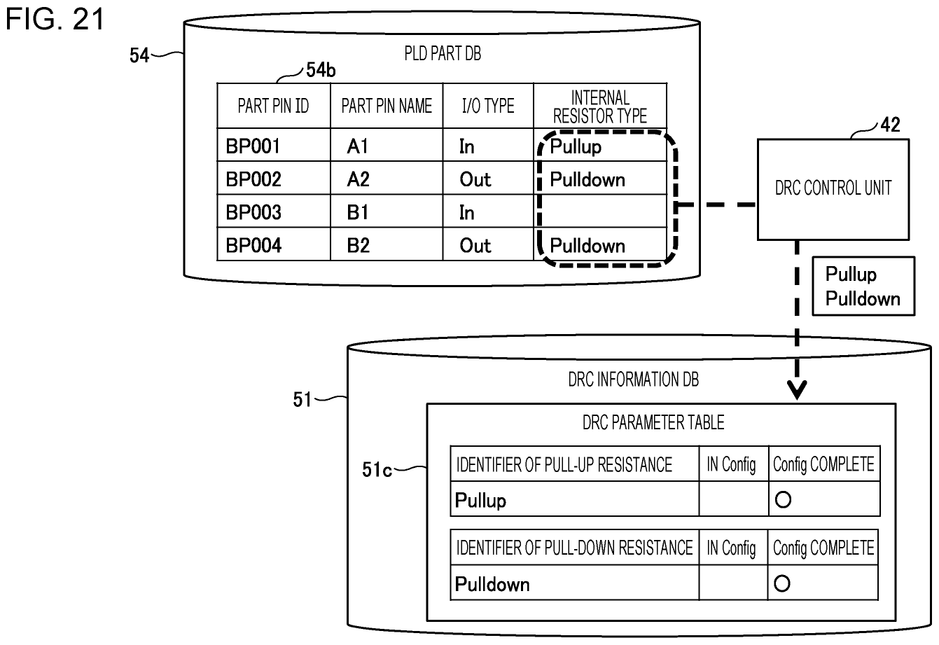

Next, setting of parameters for performing the mix check of the pull-up resistor and the pull-down resistor, which is performed by the DRC control unit 42, will be described. FIG. 21 is a diagram for illustrating an outline of a parameter setting process of the mix check by a DRC control unit.

In FIG. 21, the DRC control unit 42 acquires the character string of the internal resistor type of the PLD part pin table 54b of the PLD part DB 54, and sets the identifier of the pull-up resistor and the identifier of the pull-down resistor for detecting the internal resistor at the time of the mix check.

In this example, the DRC control unit 42 acquires “Pullup” and “Pulldown” from the set value of the internal resistor type of the PLD part pin table 54b. The DRC control unit 42 sets “Pullup” and “Pulldown” as the identifier of the pull-up resistor and the identifier of the pull-down resistor respectively of the DRC parameter table 51c of the DRC information DB 51.

The DRC control unit 42 may extract the character string from the internal resistor type of the PLD part pin table 54b, and allow the user to select the character string to be set as the identifier of the pull-up resistor and the character string to be set as the identifier of the pull-down resistor.

The DRC control unit 42 performs setting so that the presence and absence of detection of the internal resistor may be controlled during the mix check. Specifically, the DRC control unit 42 acquires from the user whether the corresponding PLD circuit is a phase in design and is subjected to the mix check or is a phase of complete design and is subjected to the mix check. The DRC control unit 42 sets a mark (“O” as an example) to “In Config” or “Config complete” in the PLD part pin table 54b.

The mix check is controlled as follows.
1. In a case where the mark is set in “In Config”, at the time of the mix check, a temporary mix check may be performed by detecting only the internal resistor during the design with respect to the character string set in the PLD part pin table 54b.
2. In a case where the mark is set to “Config complete”, excessive errors may be reduced by suppressing detection of the internal resistor during the design at the time of the mix check.

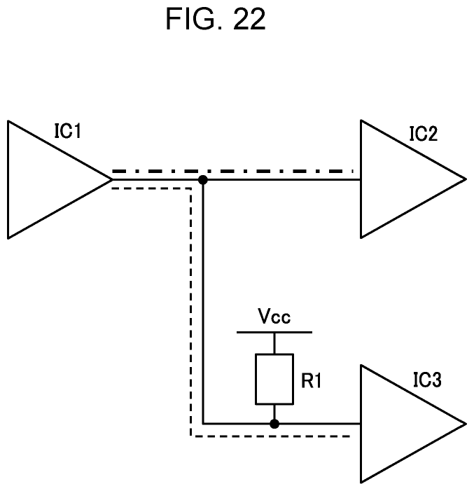

FIG. 22 is a diagram for illustrating a path data construction process by a DRC processing unit. The DRC processing unit 43 extracts a net coupled between the ICs including the PLD parts from the circuit DB 52 according to the circuit diagram and the pull-up resistor or the pull-down resistor coupled with the net.

From the couple between the ICs in the circuit diagram illustrated in FIG. 22, a duplication check on these two paths of ⋅couple between the IC1 and IC2 and ⋅couple between the IC1 and IC3 is performed.

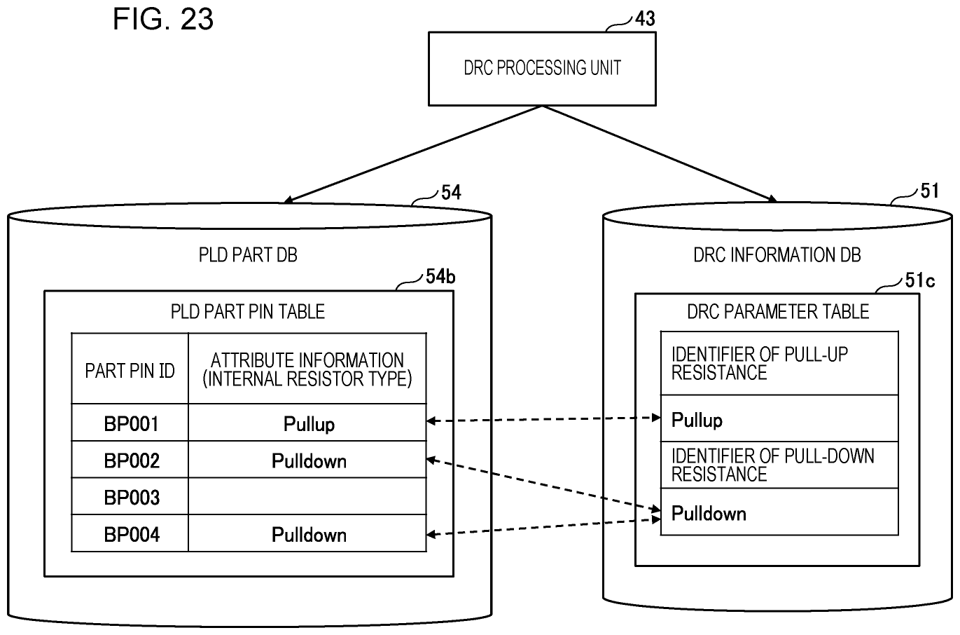

FIG. 23 is a diagram for illustrating a determination process of a pin having an internal resistor by the DRC processing unit. According to FIG. 23, regarding a path trace start part pin (StartPin) and an end part pin (EndPin), in a case where the part to which the pin belongs is a PLD part, the DRC processing unit 43 acquires the internal resistor type from the PLD part pin table 54b of the PLD part DB 54.

In a case where the value of the acquired internal resistor type (for example, a character string) matches the value registered in the DRC information DB 51, the DRC processing unit 43 determines that the pin of the PLD part is the part pin including the internal pull-up resistor or the internal pull-down resistor. The presence or absence of part pins including the internal pull-up resistors or the internal pull-down resistors is determined for all paths.

The DRC processing unit 43 specifies, for each path, a resistor part whose the logic type indicates the pull-up resistor or the pull-down resistor among coupling parts such as ICs, PLDs, and resistors.

FIG. 24 is a flowchart for illustrating a tracing process by a DRC processing unit. According to FIG. 24, with reference to the part table 52b and the part pin table 52d of the circuit DB 52, the DRC processing unit 43 acquires IDs of the output pins and the input and output pins of IC parts including PLD parts, and creates a part pin ID list (operation S311). The created part pin ID list is specified as ICPinList in the storage unit 130.

The DRC processing unit 43 executes a path tracing process for extracting parts coupled for each path by operations S312 to S317. In the path tracing process, variables are defined as follows. One path is a wiring path from the start part pin to the end part pin between two IC parts. ⋅As StartPin, the part pin ID (start part pin ID) that corresponds to the start point of the trace is set. ⋅ICPinList.begin designates the start part pin ID of the part pin list. ⋅ICPinList.end designates an end part pin ID of the part pin list. ⋅As EndPin, the part pin ID (end part pin ID) that corresponds to the end point of the trace is set. ⋅netPinList is a table of a list of part pin IDs coupled with the same path. ⋅C-Parts indicates an ID of a part coupled between the start part pin and the end part pin. ⋅PathList is a table of the path list.

After initial setting of the start part pin ID (StartPin), the DRC processing unit 43 sequentially selects the part pins from the start part pin to the end part pin of the path (operation S312). In the initial setting, the start part pin ID of the part pin ID list (ICPinList) is set as the start part pin ID (StartPin). Each time it repeats, the start part pin ID (StartPin) is updated in order, and when it is determined that the start part pin ID (StartPin) matches the end part pin ID in the part pin ID list (ICPinList) by repeated determination after the following process, the process exits from this loop.

The DRC processing unit 43 acquires the net ID with reference to the net table 52c via the part pin table 52d using the start part pin ID (StartPin), and sets the net ID as Net (operation S313).

Next, the DRC processing unit 43 acquires the part pin ID to be coupled next from the net table 53c specified by Net, and creates a net part pin list (operation S314). The created net part pin list is specified as netPinList in the storage unit 130.

The DRC processing unit 43 executes a coupling part tracing process that specifies the IC part on the path (operation S315). In response to the end of the coupling part tracing process, the DRC processing unit 43 creates, as path data, a path list indicating the part pin ID specified by StartPin and EndPin and the part ID specified by C-Parts obtained by the above-described process (operation S317). The created path list is specified as PathList in the storage unit 130.

The DRC processing unit 43 determines whether or not a path to be traced still exists (operation S317). In a case where the start part pin ID (StartPin) does not match the end part pin ID (EndPin), it may be determined that an unprocessed path exists. In this case, the DRC processing unit 43 returns to the operation S312, sets the next part ID in the part pin ID list (ICPinList) as the start part pin ID (StartPin), and repeats the above-described process.

On the other hand, in a case where the start part pin ID (StartPin) matches the end part pin ID (EndPin), the DRC processing unit 43 determines that the trace has been completed for all paths, and ends the tracing process.

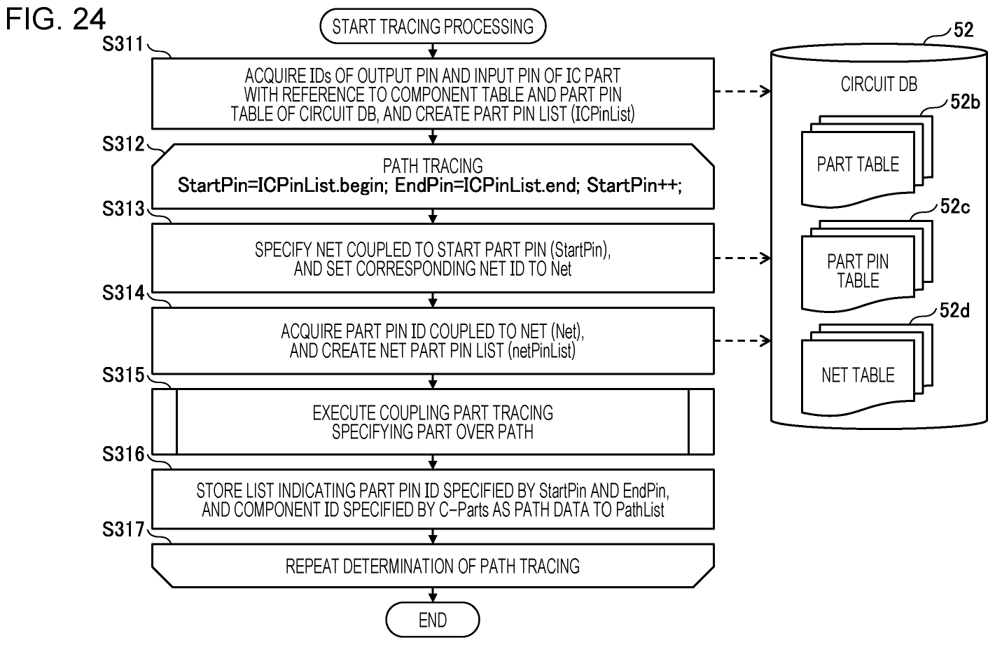

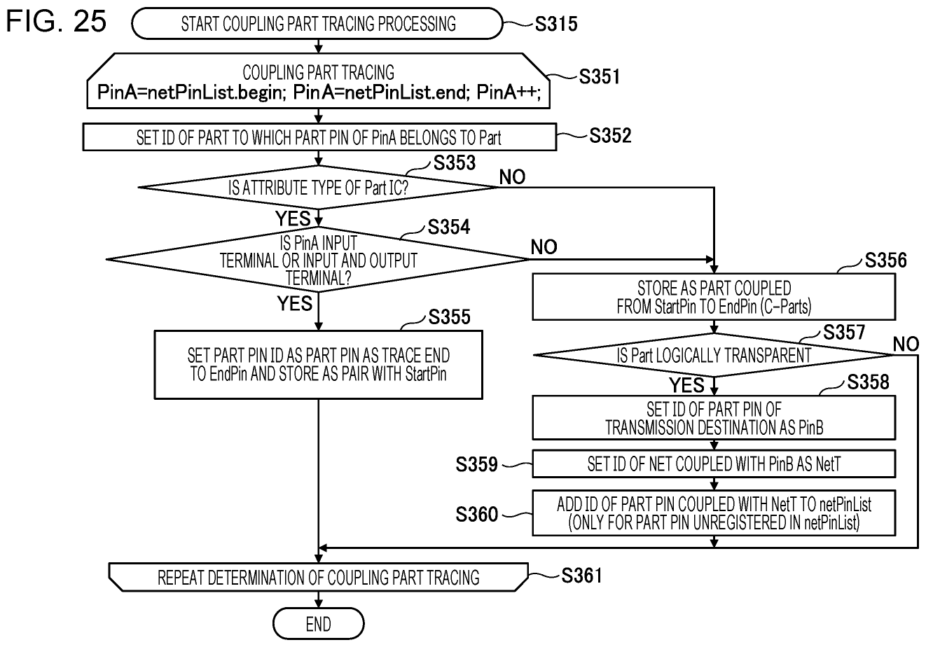

FIG. 25 is a flowchart for illustrating a coupling part tracing process in an operation S315 of FIG. 24. In FIG. 25, variables are defined as follows. ⋅As PinA, the part pin ID to be processed is set in order from the net part pin list (netPinList). ⋅As Part, an ID of a part to which the part pin specified by PinA belongs is set. ⋅netPinList.begin designates the start part pin ID of the net part pin list (netPinList). ⋅netPinList.end designates the end part pin ID of the net part pin list (netPinList). ⋅C-Parts indicates a list of IDs of parts coupled with the path. ⋅PinB indicates the ID of the part pin that is the transmission destination. In a case where an input signal and an output signal do not change between a plurality of nets coupled with one part, the part may be considered as a part that does not logically exist. Such a concept of transparency is called logic transparency, and such a part is called a logically transparent part. As the PinB, the ID of the transmission destination part pin is set.

The DRC processing unit 43 performs the initial setting to set the start part pin ID of the net part pin list (netPinList) as PinA, and each time the coupling part tracing process is repeated, the PinA is updated with the part pin ID acquired in order from the net part pin list (netPinList) (operation S351). The DRC processing unit 43 sets the ID of the part to which the part pin of PinA belongs to as the Part with reference to the part library DB 53 (operation S352).

The DRC processing unit 43 checks whether or not an attribute type indicates IC with reference to the part library table 53a in the part library DB 53 (operation S353). In a case where the attribute type is IC (YES in operation S353), the DRC processing unit 43 determines whether or not the attribute type indicates an input terminal or an input and output terminal with reference to the part pin library table 53b of the PinA in the part library DB 53 (operation S354).

In a case where the attribute type indicates the input terminal or the input and output terminal (YES in operation S354), the DRC processing unit 43 sets the part pin ID as EndPin as the part pin at the end of the trace, and stores the EndPin as a pair with StartPin (operation S355).

Thereafter, the DRC processing unit 43 repeatedly performs the determination (operation S361). It may only determine whether or not the PinA matches the end part pin ID in the net part pin list (netPinList). In a case where the PinA does not match the end part pin ID, the DRC processing unit 43 returns to the operation S351, acquires the next part pin ID from the net part pin list (netPinList), updates PinA, and repeats the same processing as described above. On the other hand, in a case where the PinA matches the end part pin ID, the DRC processing unit 43 ends the coupling part tracing process in the operation S315 of FIG. 24.

On the other hand, in a case where the attribute type of the part specified by the Part is not IC (NO in operation S353), or, in a case where the part pin attribute type specified by the PinA is neither an input terminal nor an input and output terminal (NO in operation S354), the DRC processing unit 43 adds and stores the part ID to C-Parts as a part coupled from the part pin of the StartPin to the part pin of the EndPin (operation S356).

Thereafter, the DRC processing unit 43 determines whether or not the part of the Part is a logically transparent part (operation S357). In a case where the part of the Part is not the logically transparent part (NO in operation S357), the DRC processing unit 43 proceeds to the operation S361 and repeatedly performs determination.

On the other hand, in a case where the part of the Part is the logically transparent part (YES in operation S357), the DRC processing unit 43 acquires the ID of the transmission destination part pin and set as the PinB with reference to the circuit DB 52 (operation S358). The DRC processing unit 43 acquires the ID of the net coupled with the part pin of the PinB and sets as NetT (operation S359).

The DRC processing unit 43 refers to the net table 52c by the NetT to acquire the ID of the part pin coupled with the tip of the NetT net from the part pin table 52d, and add (registers) the acquired ID of the part pin to the net part pin list (netPinList) (operation S360). At this time, the part pin ID is added only in a case where it is not registered in the net part pin list (netPinList). Thereafter, the DRC processing unit 43 proceeds to the operation S361 and repeatedly performs determination.

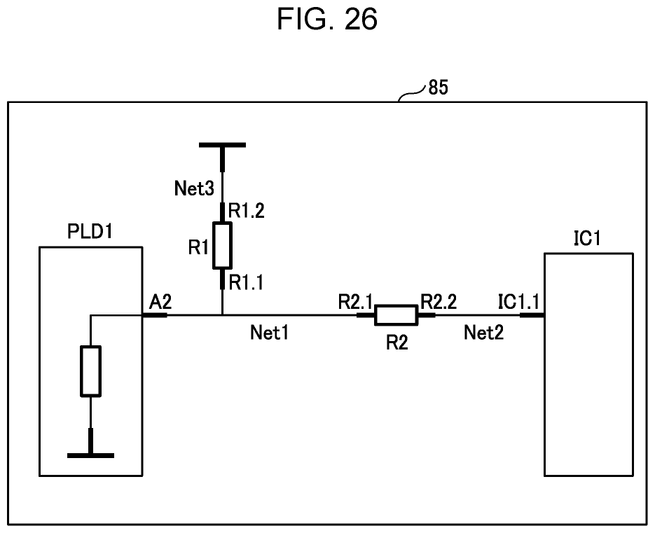

Next, an example of the tracing process between the IC parts will be described with reference to FIGS. 26 to 28. FIG. 26 is a diagram illustrating an example of a circuit diagram. In the circuit diagram 85 illustrated in FIG. 26, the PLD1 and the IC1 are coupled. The tracing process between the IC parts is not limited to the path from PLD to IC. Any of a path from IC to IC, a path from IC to PLD, and a path from PLD to PLD may be used. The type of the integrated circuit is not limited.

In the path between the PLD1 and the IC1, an output pin A2 of the PLD1 is set as a start part pin, an input pin IC1.1 of the IC1 is set as an end part pin, and the DRC processing unit 43 extracts the part IDs of the R1 and R2 as coupling parts in this path.

The R1 which is a part on the path has a pin R1.1 and a pin R1.2, and The R2 has a pin R2.1 and a pin R2.2. In the path between the PLD1 and the IC1, the pin A2 of the PLD1 is first coupled with a pin R2.1 of the R2. This coupling (net) is identified by Net1.

In the R2 on the path, the pin R2.2 is coupled with the pin IC1.1 of the IC1 and this coupling (net) is identified by Net1. On the other hand, the Net1 is also coupled with the pin R1.1 of the R1.

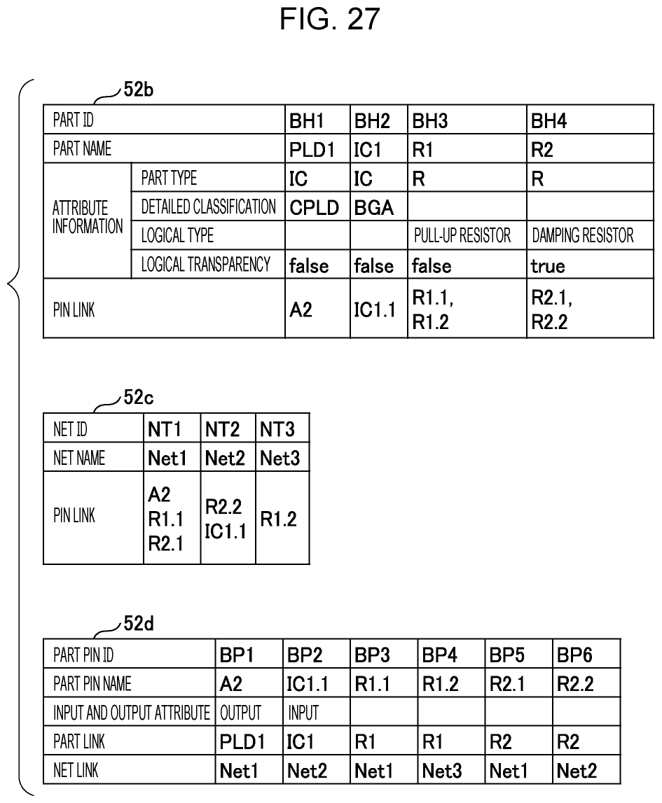

FIG. 27 is a diagram illustrating a data example of the circuit DB based on the circuit diagram of FIG. 26. In FIG. 27, only data referred to by the DRC processing unit 43 for performing the tracing process is illustrated, and the others are not illustrated.

According to FIG. 27, in the part table 52b, in order to specify the parts, “BH1”, “BH2”, “BH3”, and “BH4” are assigned to the part names “PLD1”, “IC1”, “R1”, and “R2” as unique part IDs in the circuit DB 52.

The attribute information of the PLD1 includes a part type “IC”, a detailed classification “CPLD”, and logical transparency “false”, and the pin link is “A2”. The attribute information of the IC1 includes a part type “IC”, a detailed classification “BGA”, and logical transparency “false”, and the pin link is “IC1.1”.

The attribute information of the R1 includes a part type “R (resistor)”, a logical type “pull-up resistor”, and logical transparency “false”, and the pin links are “R1.1” and “R1.2”. The attribute information of the R2 includes a part type “R (resistor)”, a logical type “damping resistor”, and logical transparency “true”, and the pin links are “R2.1” and “R2.2”.

In the part pin table 52d, in order to specify coupling information, “NT1”, “NT2”, and “NT3” are assigned to the net names “Net1”, “Net2”, and “Net3” as unique net IDs in the circuit DB 52, respectively. The pin links of the Net1 are “A2”, “R1.1”, and “R2.1”, the pin links of the Net2 are “R2.2” and “IC1.1”, and the pin link of the Net3 is “R1.2”.

In the part pin table 52d, in order to specify the part pins, “BP1”, “BP2”, “BP3”, “BP4”, “BP5”, and “BP6” are assigned to the part pin names “A2”, “IC1.1”, “R1.1”, “R1.2”, “R2.1”, and “R2.2” as unique part pin IDs in the circuit DB 52.

Regarding the A2, an input and output attribute “output”, a part link “PLD1”, and a net link “Net1” are indicated. Regarding the IC1.1, an input and output attribute “input”, a part link “IC1”, and a net link “Net2” are indicated. Regarding the R1.1, a part link “R1”, and a net link “Net1” are indicated. Regarding the R1.2, a part link “R1”, and a net link “Net3” are indicated. Regarding the R2.1, a part link “R2”, and a net link “Net1” are indicated. Regarding the R2.2, a part link “R2”, and a net link “Net1” are indicated.

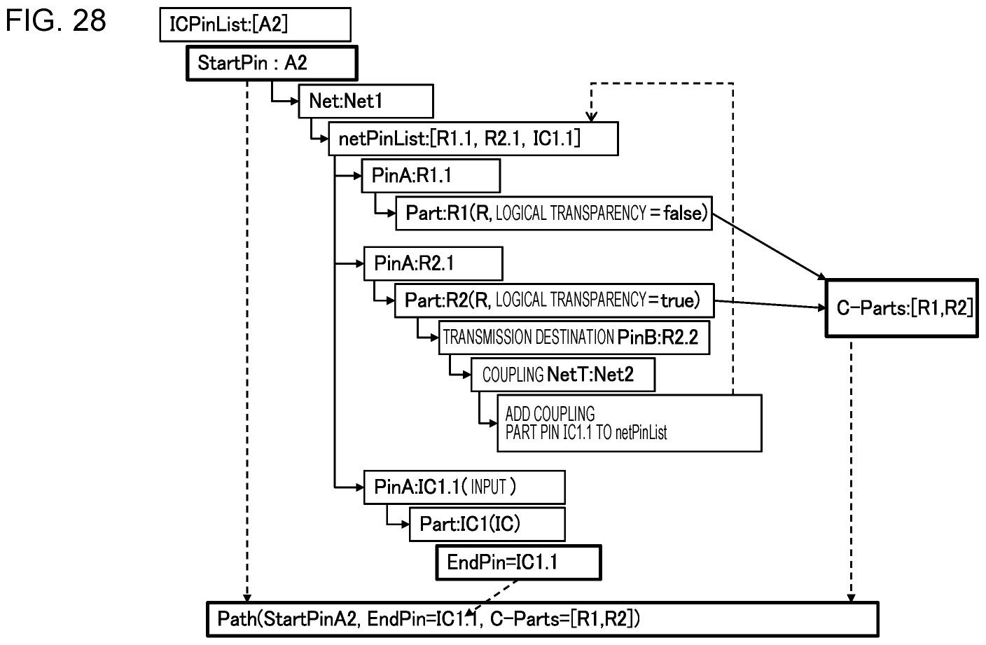

By the tracing process (FIGS. 24 and 25) executed based on such data examples, processing results in the circuit design apparatus 100 as illustrated in FIG. 28 are obtained in the storage unit 130. FIG. 28 is a diagram illustrating a relationship between a value obtained by the tracing process and a variable.

According to FIG. 28, in the circuit diagram 85 of FIG. 26, since there is only one pin belonging to the PLD1, in the tracing process, only one pin ID “A2” is stored in the ICPinList (part pin ID list) in the storage unit 130 (operation S311 in FIG. 24). One pin ID is selected in order from ICPinList (part pin ID list) and set as StartPin (trace start pin). In this example, “A2” is set (operation S312 in FIG. 24).

In the operation S313 of FIG. 24, the Net1 is set as Net with reference to the part pin table 52d. In the operation S314, “R1.1” and “R2.1” are first stored in the netPinList (net part pin ID list) with reference to the net table 52c.

In FIG. 25, in the first operation S351, the first “R1.1” is first set as the PinA from the netPinList (net part pin ID list). After that, in the operation S352, “R1” is set as Part with reference to the part table 52b, and by the operations S356 and S357, “R1” is added to the C-Parts, and is determined not to be a logically transparent part.

In the second operation S351, the next “R2.1” is set as the PinA from the netPinList (net part pin ID list). After that, in the operation S352, “R2” is set as Part with reference to the part table 52b, and by the operations S356 and S357, “R2” is added to the C-Parts, and is determined to be a logically transparent part.

By the operation S358, “R2.2” is set as the PinB with reference to the part table 52b, and by the operation S359, “Net2” is set as the NetT with reference to the part pin table 52d. By the operation S360, “IC1.1” is added to the netPinList with reference to the net table 52c.

In the third operation S351, the next “IC1.1” is set as the PinA from the netPinList (net part pin ID list). After that, in the operation S352, “IC1” is set as the Part with reference to the part table 52b, and the part type “IC” is added to the Part from the part table 52b in the operation S353. In the operation S354, with reference to the part pin table 52d, the input and output attribute “input” indicating that “IC1.1” is an input pin is added to the PinA. In the operation S355, “IC1.1” is set as the EndPin.

In the operation S361, it is determined that there is no unprocessed part ID in the ICPinList (part pin ID list), and the path data is stored in the Path. Specifically, the value of StartPin “A2”, the value of EndPin “IC1.1”, and the values of C-Parts “R1” and “R2” are stored in the Path in the storage unit 130.

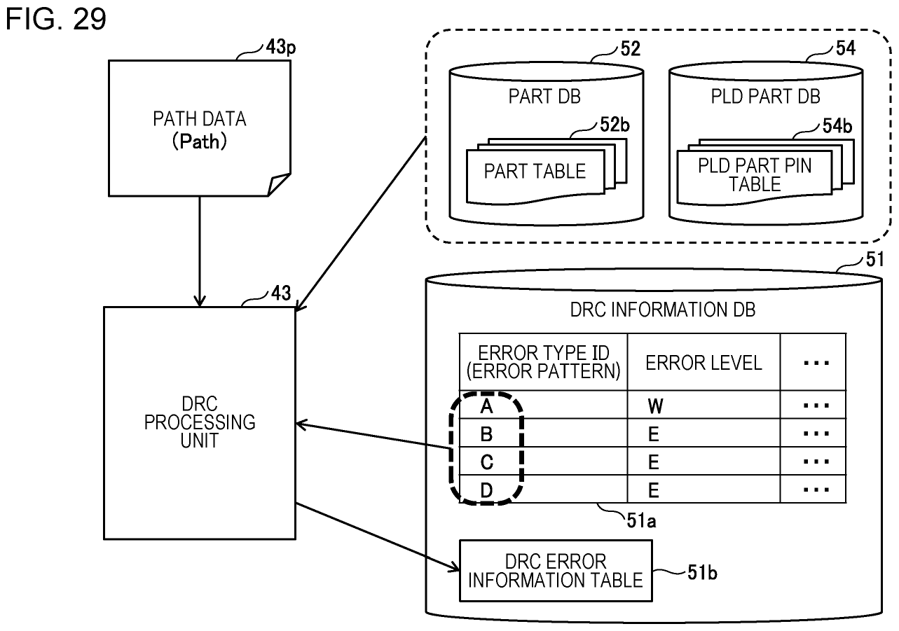

In FIG. 26, the circuit diagram 85 in the case of one path is illustrated, so that it is determined that the trace has been completed for all the paths by the repeated determination in the operation S317 in FIG. 24. Therefore, the Path illustrated in FIG. 26 becomes path data 43p (FIG. 29) in the circuit diagram 85.

FIG. 29 is a diagram for illustrating an outline of the mix check by the DRC processing unit. According to FIG. 29, the DRC processing unit 43 is based on the path data 43p obtained by the tracing process, the mix check of the pull-up resistor and the pull-down resistor is executed with reference to the part DB 52, the PLD part DB 54, and the DRC information DB 51.

In the mix check, with reference to the part table 52b of the part DB 52, it is checked whether a B product included in the path is the pull-up resistor or the pull-down resistor. With reference with the PLD part pin table 54b of the PLD part DB 54, the presence or absence of a pin having an internal resistor is checked.

In a case where the mix of the pull-up resistor and the pull-down resistor is checked, with reference to the DRC definition table 51a of the DRC information DB 51, the DRC processing unit 43 specifies the corresponding error pattern, and stores the result obtained by the mix check in the DRC error information table 51b.

According to FIG. 29, as the DRC definition relating to the mix check of the DRC definition table 51a, the error level of the error type ID “A” is indicated as “W (warning)”, and the error level of the error type ID “B” is indicated as “E (error)”. The error level of the error type ID “C” and the error type ID “D” is indicated as “E”. In the following description, explanation will be made based on this DRC definition, but it may be defined as appropriate by the user.

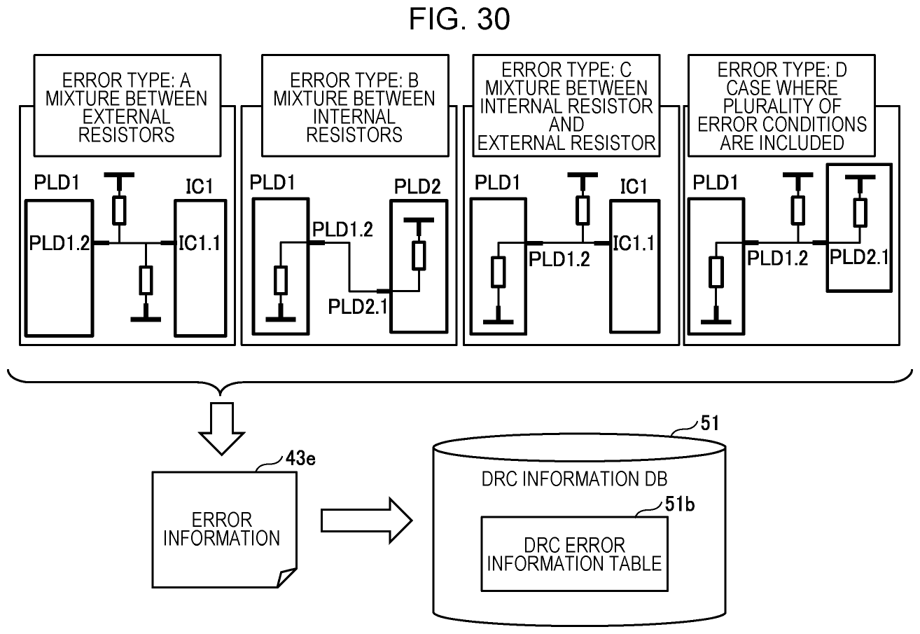

FIG. 30 is a diagram illustrating a DRC definition example. According to FIG. 30, the error type “A” corresponds to a case where the external resistor is a mixture of the pull-up resistor and the pull-down resistor in the path of two coupled circuits. The error type “B” corresponds to a case where the internal resistor is a mixture of the pull-up resistor and the pull-down resistor in the path of two coupled circuits.

The error type “C” corresponds to a case where the pull-up resistor and the pull-down resistor are mixed by the internal resistor and external resistor in the path of two coupled circuits. The error type “D” corresponds to a case where a plurality of error conditions are included due to a mixture of pull-up resistors and pull-down resistors in the path of two coupled circuits. The plurality of error conditions is a condition that corresponds to two or more of error types “A” “B”, and “C”.

When the DRC processing unit 43 obtains the error information 43e by obtaining the error type ID, the error level and the like with reference to the DRC definition table 51a, the DRC processing unit 43 stores the obtained error information 43e in the DRC error information table 51b.

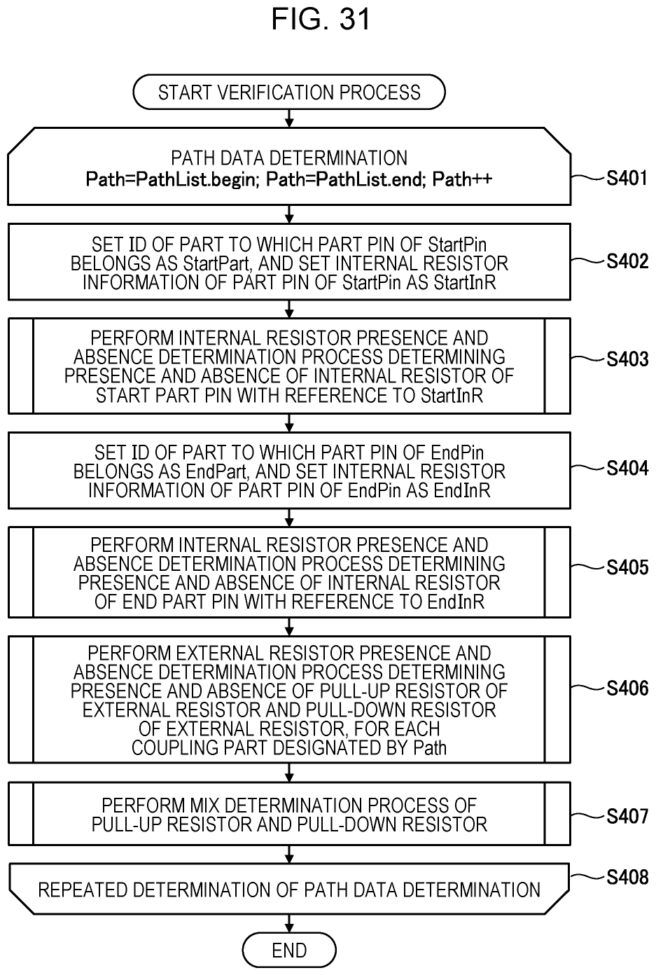

FIG. 31 is a flowchart for illustrating a verification process by the DRC processing unit. In the verification process of FIG. 31, variables are defined as follows. ⋅Path indicates path data of one path. ⋅PathList.begin designates start path data of the path list. ⋅PathList.end designates end path data in the path list. ⋅StartPin indicates the start part pin ID. ⋅StartPart indicates the ID of the start part. ⋅As StartInR, the internal resistor information of the start part pin is set. ⋅EndPin indicates the end part pin ID. ⋅EndPart indicates the ID of the end part. ⋅As EndInR, the internal resistor information of the end part pin is set.

The DRC processing unit 43 performs initial setting of a path (Path) and performs a process described below (operation S401). In the initial setting, the start path data of the path list (Path List) is set as the path (Path). Each time the path data determination by operations S402 to S408 is repeated, the path (Path) is updated in order, and when it is determined that the updated path (Path) matches the end path data in the path list (PathList) by repeated determination after the following process, the process exits from this loop.

The DRC processing unit 43 specifies the start part pin and acquires the internal resistor information of the start part pin (operation S402). Specifically, with reference to the circuit DB52, the DRC processing unit 43 acquires the ID of the part to which the part pin (start part pin) of the start part pin ID (StartPin) designated by the path (Path) belongs, and sets the acquired ID of the part as the start part D (StartPart). The DRC processing unit 43 also acquires the internal resistor information of the start part pin with reference to the circuit DB 52 and the PLD part DB 54, and sets the acquired internal resistor information of the start part pin as StartInR.

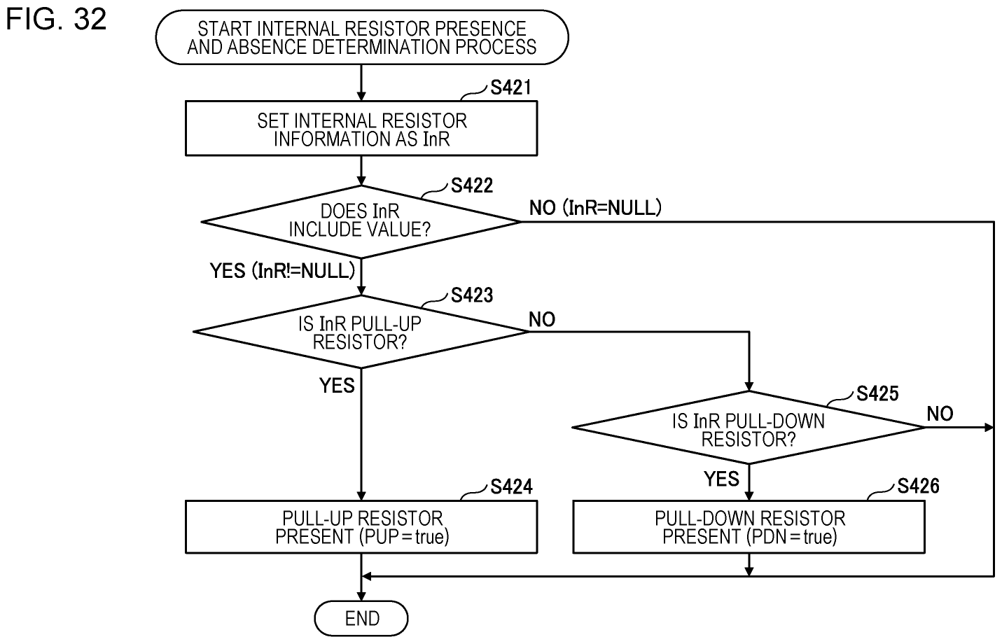

The DRC processing unit 43 an internal resistor presence and absence determination process of determining the presence and absence of the internal resistor of the start part pin with reference to the internal resistor information of the start part pin (StartInR) (operation S403). The internal resistor presence and absence determination process is described in detail in FIG. 32.

Next, the DRC processing unit 43 specifies an end part pin and acquires internal resistor information of the end part pin (operation S402). Specifically, with reference to the circuit DB52, the DRC processing unit 43 acquires the ID of the part to which the part pin (end part pin) of the end part pin ID (EndPin) designated by the path (Path) belongs, and sets the ID of the part as the start part D (EndPart). The DRC processing unit 43 also acquires the internal resistor information of the end part pin with reference to the circuit DB 52 and the PLD part DB 54, and sets the acquired internal resistor information of the start part pin as EndInR.

The DRC processing unit 43 the internal resistor presence and absence determination process of determining the presence and absence of the internal resistor of the end part pin with reference to the internal resistor information of the end part pin (EndInR) (operation S405). The internal resistor presence and absence determination process of the end part pin is realized by the same process in the case of the start part pin.

When the internal resistor presence and absence determination process with respect to the start part pin and the end part pin is completed, the DRC processing unit 43 performs an external resistor presence and absence determination process of determining presence and absence of the pull-up resistor and the pull-down resistor of the external resistor (operation S406). The DRC processing unit 43 performs the external resistor presence and absence determination process for each coupling part designated by the path data (Path).

The DRC processing unit 43 performs a mix determination process of determining whether or not the pull-up resistor and the pull-down resistor are mixed (operation S407). When the result of the mix determination process is obtained, the DRC processing unit 43 repeatedly performs the determination (operation S408).

In the repeated determination, it is checked whether or not the mix determination process has been completed for all paths. Specifically, the DRC processing unit 43 determines whether or not the Path indicates the end path data (PathListend). In a case where the Path does not indicate the end path data (PathListend), the DRC processing unit 43 returns to the operation S401, acquires the next path data from the path list (PathList), and repeats the same process as described above. In a case where the Path indicates the end path data (PathListend), the DRC processing unit 43 ends this verification process.

FIG. 32 is a flowchart for illustrating the internal resistor presence and absence determination process by the DRC processing unit. In FIG. 32, the DRC processing unit 43 sets the internal resistor information as InR (operation S421). Specifically, in a case where the internal resistor presence and absence determination process is executed in the operation S403 of FIG. 31, the DRC processing unit 43 sets the internal resistor information set in StartInR as InR. Specifically, in a case where the internal resistor presence and absence determination process is executed in the operation S405, the DRC processing unit 43 sets the internal resistor information set in EndInR as InR.

The DRC processing unit 43 determines whether or not the internal resistor information (InR) includes a value (operation S422). In a case where the internal resistor information does not include a value (NO in operation S422), that is, when the InR is NULL, the DRC processing unit 43 ends the internal resistor presence and absence determination process.

On the other hand, in a case where the internal resistor information (InR) includes a value (YES in operation S422), that is, when the InR is not NULL, the DRC processing unit 43 determines whether or not the internal resistor information (InR) indicates the pull-up resistor (operation S423). In a case where the InR indicates the pull-up resistor (YES in operation S423), the DRC processing unit 43 sets the pull-up resistor (PUP=true) as a return value (operation S424), and the internal resistor presence and absence determination process is ended.

On the other hand, in a case where the InR does not indicate the pull-up resistor (NO in operation S423), the DRC processing unit 43 further determines whether or not the internal resistor information (InR) indicates the pull-down resistor (operation S425). In a case where the InR indicates the pull-down resistor (YES in operation S425), the DRC processing unit 43 sets the pull-down resistor (PDN=true) as a return value (operation S426), and the internal resistor presence and absence determination process is ended. On the other hand, in a case where the InR does not indicate the pull-down resistor (NO in operation S425), the DRC processing unit 43 ends the internal resistor presence and absence determination process.

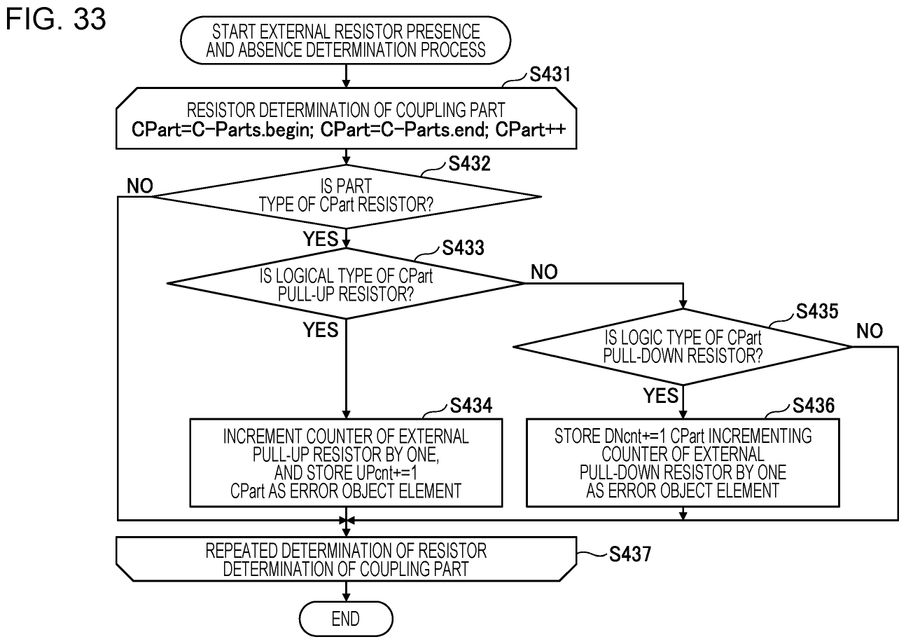

FIG. 33 is a flowchart for illustrating an external resistor presence and absence determination process by the DRC processing unit. In the external resistor presence and absence determination process of FIG. 33, variables are defined as follows. ⋅C-Parts indicates a list of coupling part IDs included in the path data (Path). ⋅C-Parts.begin designates an ID of the start coupling part in the coupling part ID list. ⋅As CPart, the ID of the coupling part to be determined is set. ⋅C-Parts.end designates an ID of the end coupling part in the coupling part ID list. ⋅UPcnt indicates a count number of the external pull-up resistor. ⋅DNcnt indicates the count number of the external pull-down resistor.

The DRC processing unit 43 performs initial setting of a coupling part ID (CPart) and performs a process described below (operation S431). Each time the DRC processing unit 43 is repeated, the coupling part ID (CPart) is selected in order up to the end coupling part ID. In the initial setting, the start part ID in the coupling part ID list (C-Parts) is set as the coupling part ID (CPart). Every time the resistor determination of the coupling parts is repeated by operations S432 to S437, the coupling part ID (CPart) is updated in order, and when it is determined that the updated coupling part ID (CPart) matches the end part ID in the coupling part ID list (C-Parts) by repeated determination after the following processing, the process exits from this loop.

The DRC processing unit 43 determines whether or not the part type of the C-Part coupling part is a resistor (R) with reference to the part DB 52 (operation S432). In a case where the part type of the C-Part coupling part is not the resistor (R) (NO in operation S432), the DRC processing unit 43 repeatedly performs the determination (operation S437), and in a case where the external resistor presence and absence is determined with respect to all of the coupling parts, the external resistor presence and absence determination process is ended. On the other hand, in a case where there is a coupling part in which the external resistor presence and absence is not determined, the DRC processing unit 43 returns to the operation S431, sets the ID of the next coupling part as CPart, and repeats the same processing as described above.

On the other hand, in a case where the part type of the C-Part coupling part is a resistor (R) (YES in operation S432), the DRC processing unit 43 determines whether or not the logical type of the C-Part coupling part is the pull-up resistor with reference to the part DB 52 (operation S433). In a case where the part type of the C-Part coupling part is the pull-up resistor (YES in operation S433), the DRC processing unit 43 increments the counter of the external pull-up resistor (UPcnt) by 1, and stores the CPart value in the storage unit 130 as an error object element (operation S434). A link to the error object element is stored in the DRC information DB 51. Thereafter, the DRC processing unit 43 repeatedly performs the determination (operation S437), and in a case where the external resistor presence and absence is determined with respect to all of the coupling parts, the external resistor presence and absence determination process is ended. On the other hand, in a case where there is a coupling part in which the external resistor presence and absence is not determined, the DRC processing unit 43 returns to the operation S431, sets the ID of the next coupling part as CPart, and repeats the same processing as described above.

On the other hand, in a case where the part type of the C-Part coupling part is the pull-up resistor (NO in operation S433), the DRC processing unit 43 determines whether or not the logical type of the C-Part coupling part is the pull-down resistor (operation S435). In a case where the part type of the C-Part coupling part is the pull-down resistor (YES in operation S435), the DRC processing unit 43 increments the counter of the external pull-down resistor (DNcnt) by 1, and stores the CPart value in the storage unit 130 as an error object element (operation S436). A link to the error object element is stored in the DRC information DB 51. Thereafter, the DRC processing unit 43 repeatedly performs the determination (operation S437), and in a case where the external resistor presence and absence is determined with respect to all of the coupling parts, the external resistor presence and absence determination process is ended. On the other hand, in a case where there is a coupling part in which the external resistor presence and absence is not determined, the DRC processing unit 43 returns to the operation S431, sets the ID of the next coupling part as CPart, and repeats the same processing as described above.

In a case where the part type of the C-Part coupling part is not the pull-down resistor (NO in operation S435), the DRC processing unit 43 repeatedly performs the determination (operation S437), and in a case where the external resistor presence and absence is determined with respect to all of the coupling parts, the external resistor presence and absence determination process is ended. On the other hand, in a case where there is a coupling part in which the external resistor presence and absence is not determined, the DRC processing unit 43 returns to the operation S431, sets the ID of the next coupling part as CPart, and repeats the same processing as described above.

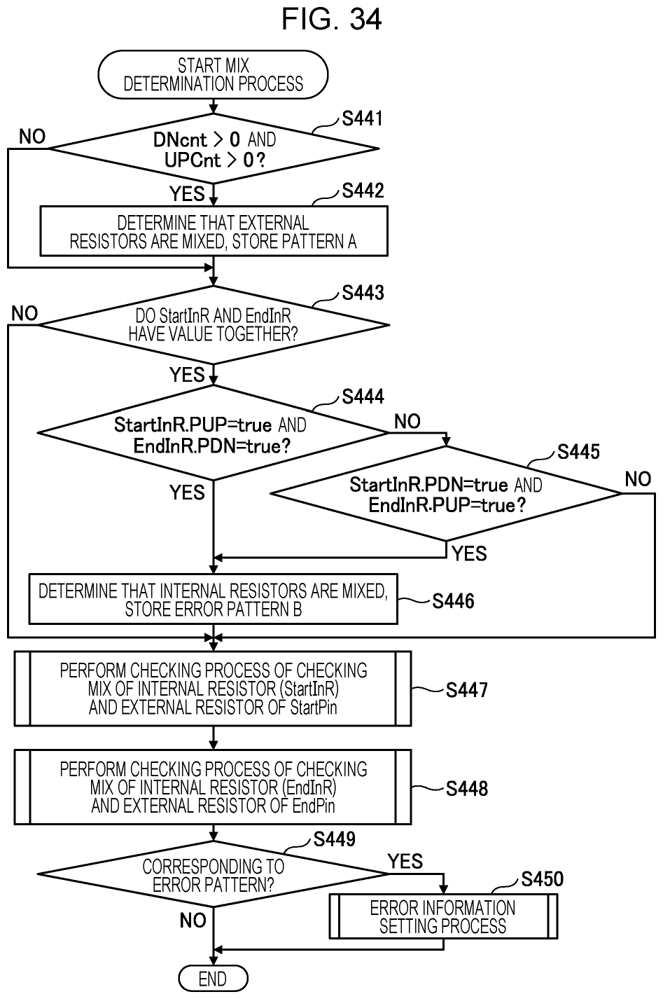

FIG. 34 is a flowchart for illustrating the external resistor presence and absence determination process by the DRC processing unit. In the mix determination process of FIG. 34, variables are defined as follows. ⋅UPcnt indicates the count number of the external pull-up resistor counted by the external resistor presence and absence determination process in FIG. 33. ⋅DNcnt indicates the count number of the external pull-down resistor counted by the external resistor presence and absence determination process in FIG. 33. ⋅StartInR indicates the internal resistor information of the start part pin in FIG. 31. For the start part pin, the presence and absence of the internal pull-up resistor and the presence and absence of the internal pull-down resistor are indicated. ⋅As EndInR, the internal resistor information of the end part pin of FIG. 31 is indicated. For the end part pin, the presence and absence of the internal pull-up resistor and the presence and absence of the internal pull-down resistor are indicated. ⋅StartInR.PUP indicates the presence and absence of the pull-up resistor of the start part pin. ⋅StartInR.PDN indicates the presence and absence of the pull-down resistor of the start part pin. ⋅EndInR.PUP indicates the presence and absence of the pull-up resistor of the end part pin. ⋅EndInR.PDN indicates the presence and absence of the pull-down resistor of the end part pin. ⋅StartPin indicates the part pin ID (start part pin ID) that corresponds to the start point of the trace. ⋅EndPin indicates the part pin ID (end part pin ID) that corresponds to the end point of the trace is set.

The DRC processing unit 43 determines whether the counter of the external pull-down resistor (DNcnt) is greater than 0 and whether the counter of the external pull-up resistor (UPcnt) is greater than 0 (operation S441). In either case where the counter of the external pull-down resistor (DNcnt) or the counter of the external pull-up resistor (UPcnt) is 0 (NO in operation S441), the DRC processing unit 43 proceeds to an operation S443.

On the other hand, in a case where the counter of the external pull-down resistor (DNcnt) and the counter of the external pull-up resistor (UPcnt) are both greater than 0 (YES in operation S441), DRC processing unit 43 determines that the external resistors are mixed, stores the error pattern A in the storage unit 130 (operation S442), and proceeds to operation S443.

Next, the DRC processing unit 43 determines whether the internal resistor information (StartInR) of the start part pin has a value and the internal resistor information (EndInR) of the end part pin has a value (operation S443). Either the internal resistor information of the start part pin (StartInR) or the internal resistor information of the end part pin (EndInR), or both have no value (NULL) (NO in operation S443), the DRC processing unit 43 proceeds to an operation S447.

On the other hand, in a case where the internal resistor information of the start part pin (StartInR) and the internal resistor information of the end part pin (EndInR) have values (present or absence) (YES in operation S443), the DRC processing unit 43 further determines whether or not the start part pin has the pull-up resistor (StartInR.PUP) and the end part pin has the pull-down resistor (EndInR.PDN) (operation S444).

In a case where the start part pin has the pull-up resistor (StartInR.PUP) and the end part pin has the pull-down resistor (EndInR.PDN) (YES in operation S444), the DRC processing unit 43 determines that the internal resistors are mixed, and stores an error pattern B in the storage unit 130 (operation S446). The error pattern B is stored in the DRC error information table 51b.

On the other hand, in a case where at least one of the pull-up resistor in the start part pin (StartInR.PUP) and the pull-down resistor in the end part pin (EndInR.PDN) is absent (NO in operation S444), or in a case where at least one of the pull-down resistor in the start part pin (StartInR.PDN) or the pull-up resistor in the end part pin (EndInR.PUP) is absent (NO in operation S445), the DRC processing unit 43 proceeds to an operation S447.

On the other hand, in a case where the start part pin has the pull-down resistor (StartInR.PDN) and the end part pin has the pull-up resistor (EndInR.PUP) (YES in operation S445), the DRC processing unit 43 determines that the internal resistors are mixed, and stores an error pattern B in the storage unit 130 (operation S446).

The DRC processing unit 43 performs a checking process of checking the mix of the internal resistor (StartInR) and the external resistor of the start part pin ID (StartPin) (operation S447), and a checking process of checking the mix of the internal resistor (EndInR) and the external resistor of the end part pin ID (EndPin) (operation S448).

When all the error patterns have been checked, the DRC processing unit 43 determines whether the configuration on the path corresponds to the error pattern (operation S449). In a case where the configuration on the path does not correspond to the error pattern (NO in operation S449), the DRC processing unit 43 ends the mix determination process.

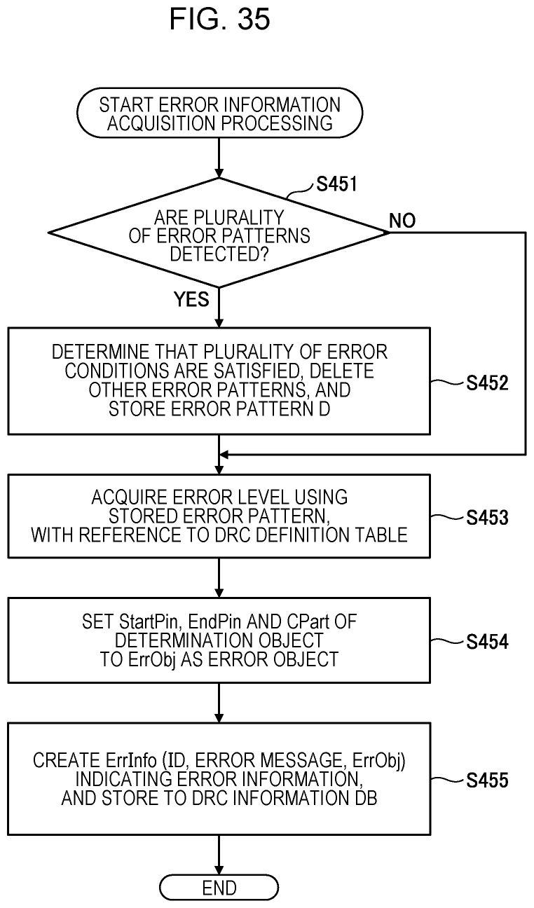

FIG. 35 is a flowchart for illustrating an error information acquisition process by the DRC processing unit. In the description of the error information acquisition process of FIG. 35, variables are defined as follows. ⋅StartPin indicates the start part pin ID in FIG. 31. ⋅EndIn indicates the end part pin ID in FIG. 31. ⋅CPart indicates the ID of the part (coupling part ID) of the determination object of FIG. 33. ⋅As ErrObj, an object of the error is set. ⋅ErrInfo indicates the error information 43e.

In FIG. 35, the DRC processing unit 43 checks the number of error patterns stored in the storage unit 130, and determines whether or not a plurality of error patterns have been detected (operation S451). In a case where the plurality of error patterns are not detected (NO in operation S451), that is, in a case where one error pattern is detected, the DRC processing unit 43 proceeds to an operation S453.

On the other hand, in a case where the plurality of error patterns are detected (YES in operation S451), the DRC processing unit 43 determines that a plurality of error conditions are satisfied, deletes other error patterns, and stores the error pattern D in the storage unit 130 (operation S452).

Next, with reference to the DRC definition table 51a, the DRC processing unit 43 acquires an error level using the error pattern stored in the storage unit 130 (operation S453). The DRC processing unit 43 creates ErrInfo (ID, error message, ErrObj) indicating the error information 43e, and stores the created ErrInfo in the DRC information DB 51 (operation S455). With reference to the created ErrInfo, the DRC processing unit 43 sets a value in the DRC error information table 51b. Thereafter, the DRC processing unit 43 ends the error information acquisition process.

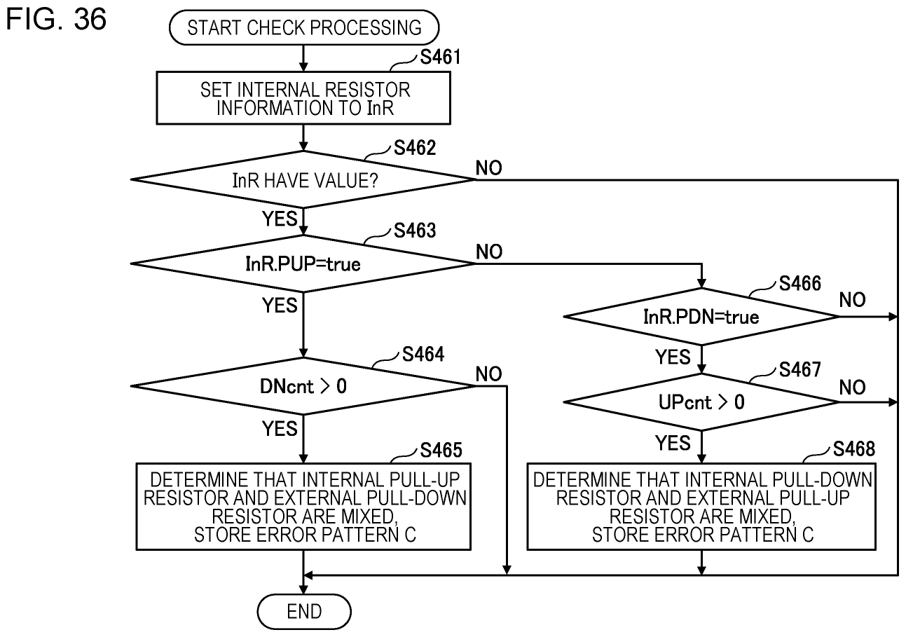

FIG. 36 is a flowchart for illustrating a checking process by the DRC processing unit. In the description of the checking process in FIG. 36, variables are defined as follows. ⋅InR indicates the internal resistor information of the start or end part pin designated in FIG. 34. The presence and absence of the internal pull-up resistor and the presence and absence of the internal pull-down resistor are indicated. ⋅InR.PUP indicates the presence and absence of the pull-up resistor of the start or end part pin. ⋅InR.PDN indicates the presence and absence of the pull-down resistor of the start or end part pin. ⋅UPcnt indicates the count number of the external pull-up resistor counted by the external resistor presence and absence determination process in FIG. 33. ⋅DNcnt indicates the count number of the external pull-down resistor counted by the external resistor presence and absence determination process in FIG. 33.

The DRC processing unit 43 sets the internal resistor information of the start or end part pin designated in FIG. 34 as InR (operation S461), and determines whether or not the internal setting information (InR) has a value (presence or absence) (operation S462). In a case where there is no set value (NO in operation S462), the DRC processing unit 43 ends this checking process.

On the other hand, in a case where there is the set value (YES in operation S462), the DRC processing unit 43 determines whether or not the internal setting information indicates that there is the pull-up resistor (InR.PUP=true) (operation S463). In a case where the pull-up resistor is present (InR.PUP=true) (YES in operation S463), the DRC processing unit 43 determines whether or not the count number of the external pull-down resistor (DNcnt) is greater than 0 (operation S464). In a case where the count number (DNcnt) is 0 (NO in operation S464), the DRC processing unit 43 ends this checking process.

On the other hand, in a case where the count number of the external pull-down resistor (DNcnt) is greater than 0 (YES in operation S464), the DRC processing unit 43 determines that the internal pull-up resistor and the external pull-down resistor are mixed, stores the error pattern C in the storage unit 130 (operation S465), and ends this checking processing.

In a case where the internal setting information does not indicate that there is the pull-up resistor, that is, in a case where no pull-up resistor is indicated (NO in operation S463), the DRC processing unit 43 determines whether or not the internal setting information indicates that there is the pull-down resistor (InR.PDN =true) (operation S466). In a case where the internal setting information does not indicate that there is the pull-down resistor, that is, in a case where no pull-down resistor is indicated (NO in operation S466), the DRC processing unit 43 ends this checking process.

On the other hand, in a case where the pull-down resistor is present (InR.PDN=true) (YES in operation S466), the DRC processing unit 43 determines whether or not the count number of the external pull-up resistor (UPcnt) is greater than 0 (operation S467). In a case where the count number (UPcnt) is 0 (NO in operation S467), the DRC processing unit 43 ends this checking process.

On the other hand, in a case where the count number of the external pull-up resistor (UPcnt) is greater than 0 (YES in operation S467), the DRC processing unit 43 determines that the internal pull-up resistor and the external pull-down resistor are mixed, stores the error pattern C in the storage unit 130 (operation S468), and ends this checking processing.

Next, an example of the verification process for the circuit diagram 85 of FIG. 26 will be described. Assume that data is set as the PLD part DB 54 as illustrated in FIG. 18 by importing the definition information 3b. In the tracing process for the circuit diagram 85, a result as illustrated in FIG. 27 may be obtained, and thus a data example of the circuit DB 52 will not be described.

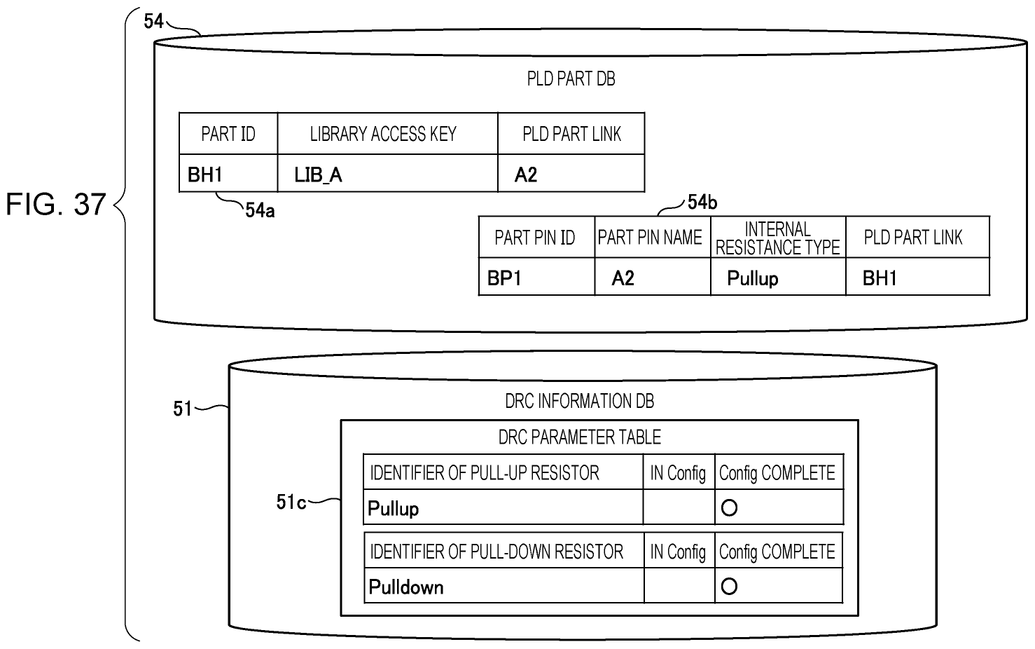

FIG. 37 is a diagram illustrating a data example of relating to PLD in the circuit diagram of FIG. 26. According to FIG. 37, in the PLD part DB 54, only the PLD1 in the circuit diagram 85 of FIG. 26 is objected, and the information is managed. In the PLD part table 54a, the library access key of the part ID “BH1” is “LIB_A”, and the PLD part link is “A2”.

In the DRC information DB 51, as illustrated in FIG. 21, the identifier of the pull-up resistor is “Pullup”, and it is valid at the completion of design (Config complete “O”) in the DRC parameter table 51c.

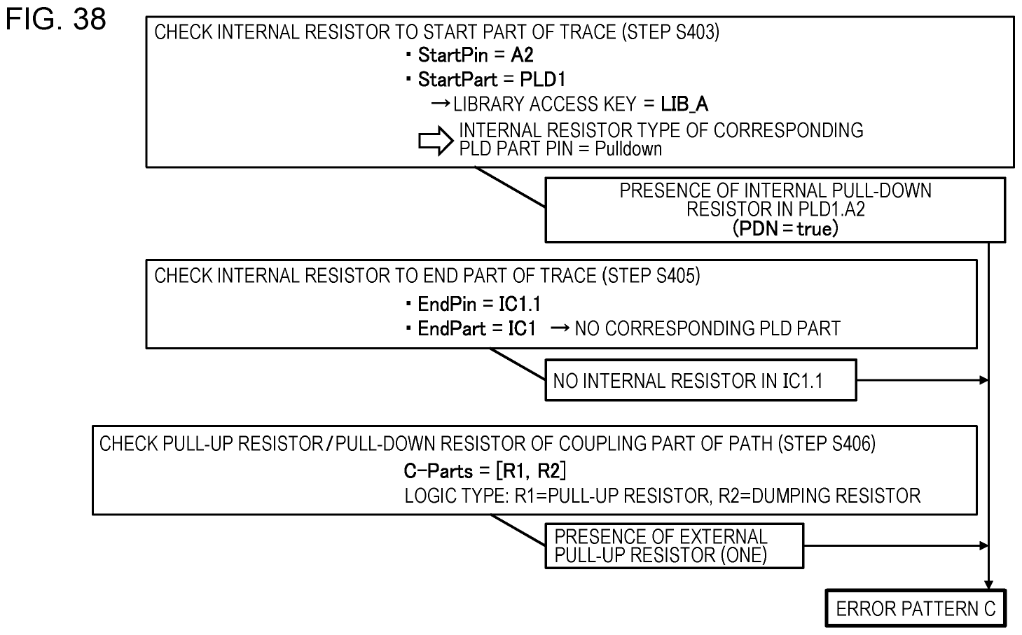

When the verification process (FIG. 31) by the DRC processing unit 43 is executed, a result as illustrated in FIG. 38 may be obtained with respect to the circuit diagram 85 of FIG. 26.

FIG. 38 is a diagram illustrating a result example of the verification process performed based on the circuit diagram of FIG. 26. According to FIG. 38, the DRC processing unit 43 performs a check for the presence or absence of the internal resistor with respect to the pin (A2) of the trace start part (PLD1 in circuit diagram 85) by the operation S403 in FIG. 31 so as to detect that the internal resistor type of the PLD part pin is the pull-down resistor. Therefore, “with internal pull-down resistor” is set for the part pin A2 of PLD1 (PDN=true).

The DRC processing unit 43 checks whether or not there is an internal resistor with respect to the pin (IC1.1) of the trace end part (IC1 in the circuit diagram 85) by the operation S405 of FIG. 31. In this case, it is determined that the pin (IC1.1) has no internal resistor.

The DRC processing unit 43 checks the pull-up resistor or the pull-down resistor of the coupling part of the path by the operation S406 in FIGS. 31. R1 and R2 are specified as coupling parts of the circuit diagram 85 by the tracing process of FIG. 24. The DRC processing unit 43 may determine that R1 is the pull-up resistor and R2 is a damping resistor with reference to the part table 52b, that is, it is detected that there is one external pull-up resistor.

From these results, it is determined that the internal pull-down resistor and the external pull-up resistor are mixed, and it is determined that the circuit diagram 85 has the error pattern C (operation S408 in FIG. 31).

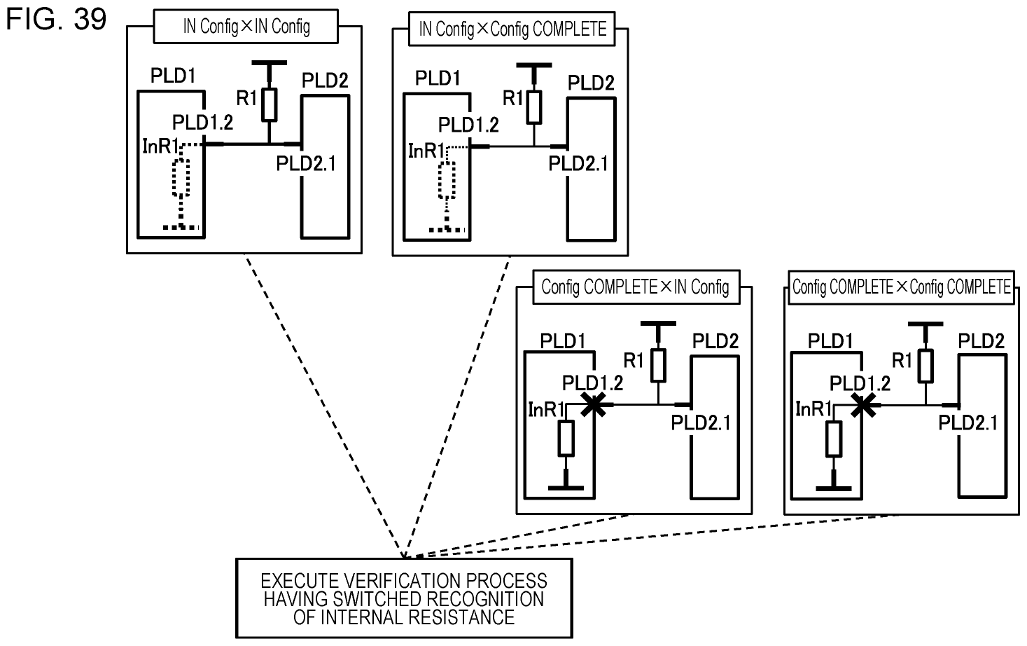

Next, the presence and absence in the error detection by the verification process in consideration of the design status of the PLD parts will be described. FIG. 39 is a diagram for illustrating presence and absence of error detection by the verification process based on a design status. In FIG. 39, the coupling between the PLD parts is described, but the present embodiment is not limited to this example.

The design status is determined based on the respective settings of the pull-up resistor and the pull-down resistor in the DRC parameter table 51c as illustrated in FIG. 21. For each of the output side PLD part and the input side PLD part, the user may make a setting for identifying or not identifying which identifier (character string) as the internal resistor InR1 for each phase of the design.

In a case of the setting of the DRC parameter table 51c illustrated in FIG. 21, the following combinations may be checked. The combination of the output side and the input side is indicated by “output side×input side”. ⋅In Config×In Config ⋅In Config×Config complete ⋅Config complete×In Config ⋅Config complete×Config complete.

In the example of FIG. 39, it is assumed that only the pin of the PLD1 on the output side has an internal resistor InR1 and is the pull-down resistor. In this case, “Pulldown” is designated as the internal resistor type of the output pin PLD1.2 of the PLD1 in the PLD part pin table 54b of the PLD part DB54. The part R1 is assumed to be a pull-up resistor.

There is no internal resistor of the PLD2 in the cases of “In Config×In Config” and “In Config×Config Complete”. The DRC processing unit 43 does not recognize the internal resistor InR1 of the PLD1. Therefore, the DRC processing unit 43 does not detect an error in these cases because R1 is the pull-up resistor but does not detect the mixed state.

There is no internal resistor of the PLD2 in the cases of “Config complete×In Config” and “Config complete×Config complete”. In these cases, the DRC processing unit 43 recognizes the internal resistor InR1 of the PLD1. Therefore, the DRC processing unit 43 detects the mixed state and determines that it is an error because R1 is the pull-up resistor.

In such a case, an error icon indicating that an error has been detected is displayed for the corresponding part pin in the circuit diagram. Hereinafter, an error display process according to this embodiment will be described. In the description of the error display process, only two paths in the circuit diagram will be described, but the number of paths is not limited to two.

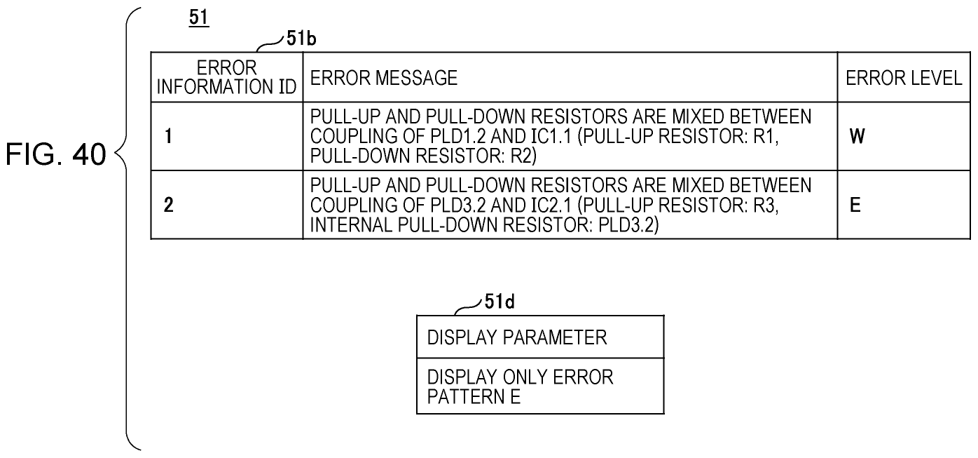

FIG. 40 is a diagram illustrating a data example of a DRC information DB in a case where an error is detected. In FIG. 40, only data examples relating to error display are illustrated, and others are not illustrated. The DRC error information table 51b indicates data examples of items such as an error information ID, an error message, and an error level. The error level indicates a value obtained from the DRC definition table 51a.

There are two records in the DRC error information table 51b, which are distinguished by error information IDs “1” and “2”. As the error message of error information ID “1”, a message of “the pull-up and pull-down resistors are mixed between the coupling of PLD1.2 and IC1.1. (pull-up resistor: R1, pull-down resistor: R2)” is stored. The error level of the error information ID “1” is “W”.

As the error message of error information ID “2”, a message of “the pull-up and pull-down resistors are mixed between the coupling of PLD3.2 and IC 2.1 (pull-up resistor: R3, internal pull-down resistor: PLD3.2)” is stored. The error level of the error information ID “2” is “E”.

In the DRC parameter table 51c, restrictions on error information to be displayed are set by display control performed in accordance with a user operation. In this example, “display only error level E” is designated in the error information.

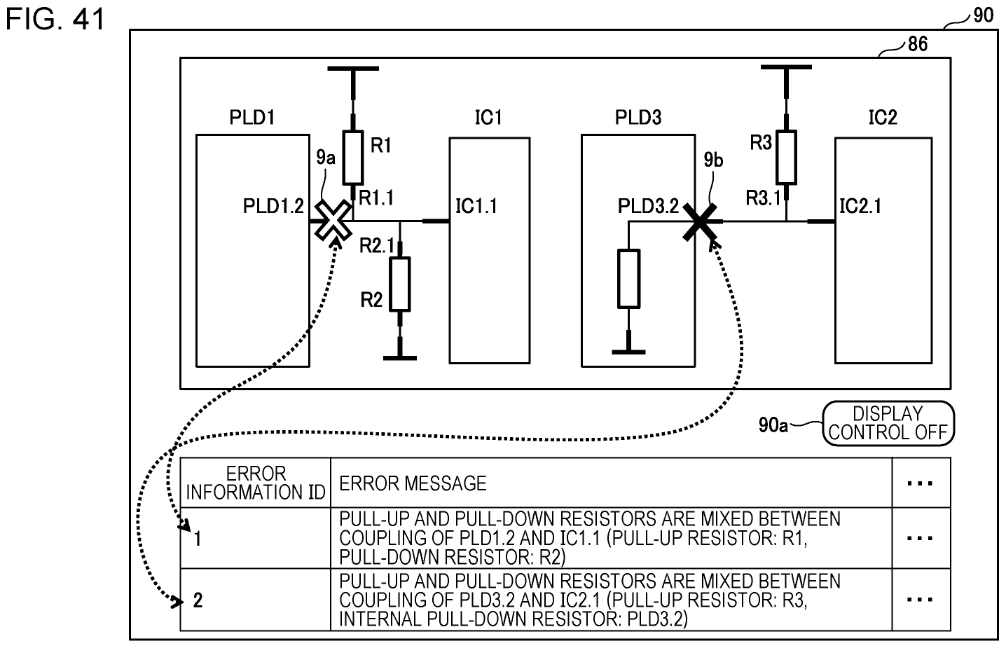

FIG. 41 is a diagram illustrating a screen example displayed based on the data example of FIG. 40. A screen G90 of FIG. 41 includes a display region of the circuit diagram 86, an error list display region in which error messages are listed, and a display control button 90a. An example in which the circuit diagram 86 including two paths is displayed is illustrated.

In the circuit diagram 86, PLD1, IC1, PLD3, IC2, R1, R2, and R3 are arranged, and there is a first path from PLD1 to IC1 and a second path from PLD3 to IC2. R1 as the pull-up resistor and R2 as the pull-down resistor exist in the first path. In the second path, R3 as the pull-up resistor exists, and the pin PLD3.2 of PLD3 has the internal pull-down resistor.

In such a circuit diagram 86, two errors are detected. In the first path, an error specified by the error information ID “1” and an error specified by the error information ID “2” are detected in the second path.

In the first path, a first error icon 9a is assigned and displayed near the output side pin PLD1.2. The first error icon 9a is linked to the error information ID “1”, and when the user selects the first error icon 9a, the error message associated with the error information ID “1” is highlighted, and the user may check the error content.

In the second path, a second error icon 9b is assigned and displayed near the output side pin PLD3.2. The second error icon 9b is linked to the error information ID “2”, and when the user selects the second error icon 9b, the error message associated with the error information ID “2” is highlighted, and the user may check the error content.

When the error message is displayed on the display device 15, the user may know the name of the part that is the error object. Therefore, it is possible to review the design at this stage. The error level may be visually recognized by using the first error icon 9a as a mark representing the warning (W) and the second error icon 9b as a mark representing the error (E).

When the user selects one of the error messages, the error location may be emphasized by blinking the error icon 1 or 2 linked to the error information ID in the circuit diagram 86. In response to the selection of the error message, the display may change to the display of the partial circuit diagram relating to the corresponding path in the circuit diagram 86, and the error icon 1 or 2 may be blinked. On the other hand, the method of emphasizing the error location is not limited to the method of blinking the error icon. Any one of the wiring, the part, the part pin, and the like may be used. In this case, any one of the wiring, the part, the part pin, and the like may be linked to the error information ID.

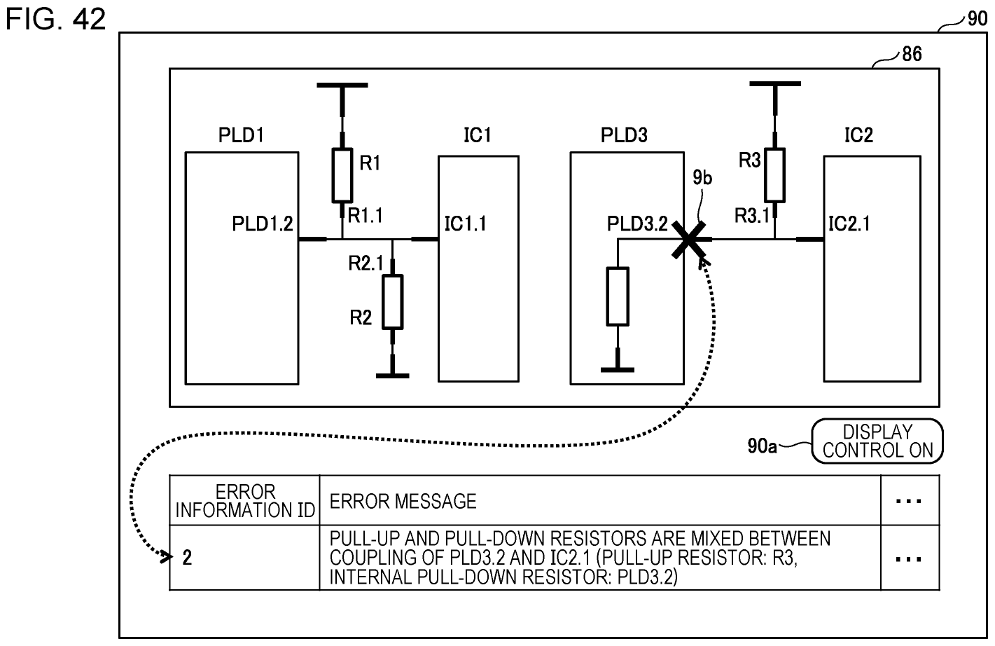

In a case where the user wants to check only the error that is the object of the design review, the display control is valid (ON) by selecting the display control button 90a. In response to the selection of the display control button 90a, a circuit diagram 86 as illustrated in FIG. 42 is displayed on the display device 15.

FIG. 42 is a diagram illustrating a screen example that is displayed in response to an operation for enabling display control. In FIG. 42, as illustrated in FIG. 41, the circuit diagram 86 is displayed on the screen 90, but only the second error icon 9b linked to the error information ID “2” is displayed over the circuit diagram 86. The display of the display control button 90a is changed from “display control OFF” (FIG. 41) to “display control ON”.

Although the error message is also displayed, only the error messages at the error level E are displayed and the error messages at the error level W are not displayed when the display control is valid. Accordingly, in this example, the error message of the error information ID “2” is only displayed.

Also on the screen 90 in FIG. 42, the circuit diagram 86 and the message may be mutually checked. The display of the error information ID is not required for the screen 90 of FIGS. 41 and 42. The display control may further include a function of displaying only specific elements, a function of hiding only specific elements, and the like according to the user's designation.

When the display control is valid, the display processing unit 48 may save the display object range of the DRC error display control table 51d in the work region of the storage unit 130, change the error level, and perform error display process described later. If the error levels “W” and “E” are display objects, the display object range may be changed so that only the error level “E” becomes a display object. The display object range saved in the storage unit 130 may be reset in the DRC error display control table 51d by the user's invalid operation of the display control, and the error display process described below may be performed.

Next, mixed patterns are indicated for each of the error types A, B, C, and D illustrated in FIG. 30. In the mixed pattern example, an example of simple coupling using the left side as an output part and the right side as an input part is used, and an error icon is displayed on the output side. These are examples of the display form and are not limited.

The output side and input side parts may be used in any case of ⋅a case of output side PLD and input side IC ⋅a case of output side IC and input side PLD ⋅a case of output side PLD and input side PLD and ⋅a case of output side IC and input side IC.

In each mixed pattern, otPUR represents the external pull-up resistor, otPDR represents the external pull-down resistor, inPUR represents the internal pull-up resistor, and inPDR represents the internal pull-down resistor. In this embodiment, various mixed patterns described below are detected so that the display corresponding to the error level in response to the error type is made possible.

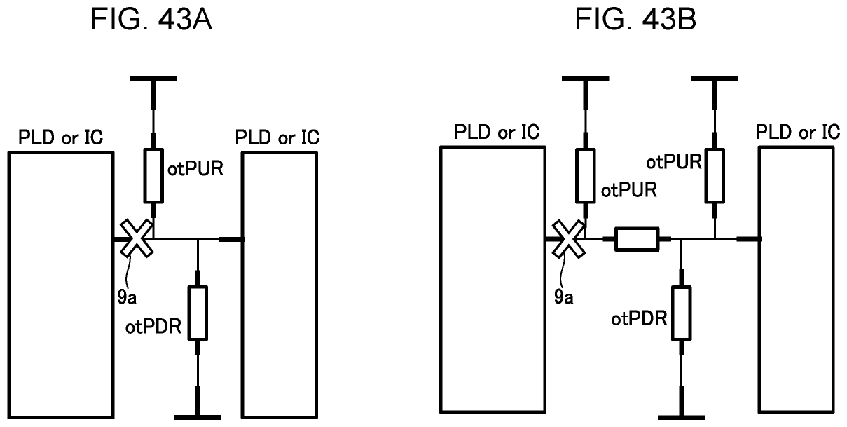

FIGS. 43A and 43B are diagrams illustrating an example of a mixed pattern between external resistors classified into an error type A. FIG. 43A illustrates a pattern in which one external pull-up resistor otPUR and one external pull-down resistor otPDR are mixed in a certain path. In such a mixed pattern of FIG. 43A, one error icon 9a representing the error level “W” is displayed.

FIG. 43B illustrates a pattern in which two external pull-up resistor otPUR and one external pull-down resistor otPDR are mixed in a certain path. Even in the mixed pattern of FIG. 43B, one error icon 9a representing the error level “W” is displayed.

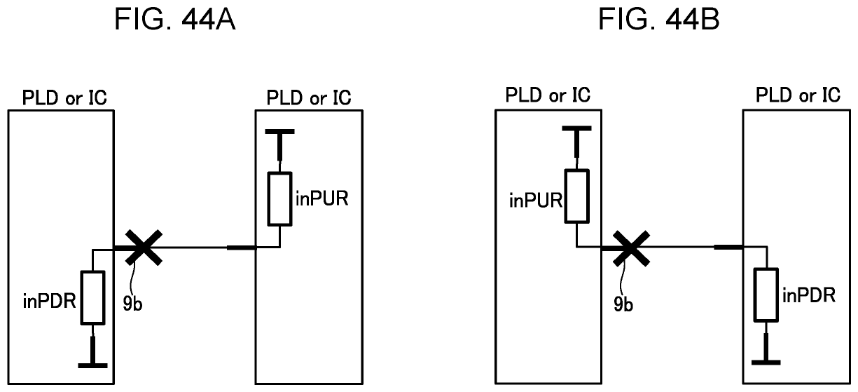

FIGS. 44A and 44B are diagrams illustrating an example of a mixed pattern between internal resistors classified into an error type B. FIG. 44A illustrates a pattern in which the internal pull-down resistor inPDR of the output pin and the internal pull-up resistor inPUR of the input pin are mixed in a certain path. In such a mixed pattern of FIG. 43A, one error icon 9b representing the error level “E” is displayed.

FIG. 44B illustrates a pattern in which the internal pull-up resistor inPUR of the output pin and the internal pull-down resistor inPDR of the input pin are mixed in a certain path. Even in the mixed pattern of FIG. 44B, one error icon 9b representing the error level “E is displayed.

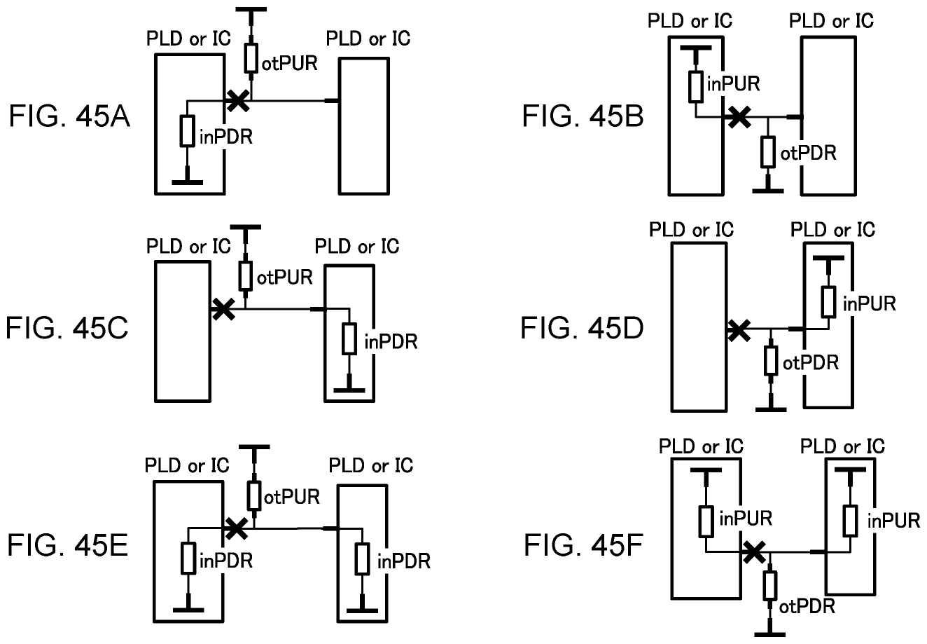

FIGS. 45A to 45F are diagrams illustrating an example of a mixed pattern between the internal resistor and the external resistor classified into an error type C. FIG. 45A illustrates a pattern in which the internal pull-down resistor inPDR of the output pin and the external pull-up resistor otPUR are mixed in a certain path. In such a mixed pattern of FIG. 45A, one error icon 9b representing the error level “E” is displayed.

FIG. 45B illustrates a pattern in which the internal pull-up resistor inPUR of the output pin and the external pull-down resistor otPDR are mixed in a certain path. Even in the mixed pattern of FIG. 45B, one error icon 9b representing the error level “E is displayed.

FIG. 45C illustrates a pattern in which the external pull-up resistor otPUR and the internal pull-down resistor inPDR of the input pin are mixed in a certain path. In such a mixed pattern of FIG. 45C, one error icon 9b representing the error level “E” is displayed.

FIG. 45D illustrates a pattern in which external pull-down resistor otPDR and the internal pull-up resistor inPUR of the input pin are mixed in a certain path. In such a mixed pattern of FIG. 45D, one error icon 9b representing the error level “E” is displayed.

In addition, FIG. 45E illustrates a pattern in which the internal pull-down resistor inPDR of the output pin and of the external pull-up resistor otPUR, the internal pull-down resistor inPDR of the input pin are mixed in a certain path. In such a mixed pattern of FIG. 45E, one error icon 9b representing the error level “E” is displayed.

FIG. 45F illustrates a pattern in which the internal pull-up resistor inPUR of the output pin and of the external pull-down resistor otPDR, the internal pull-up resistor inPUR of the input pin are mixed in a certain path. Even in the mixed pattern of FIG. 45F, one error icon 9b representing the error level “E is displayed.

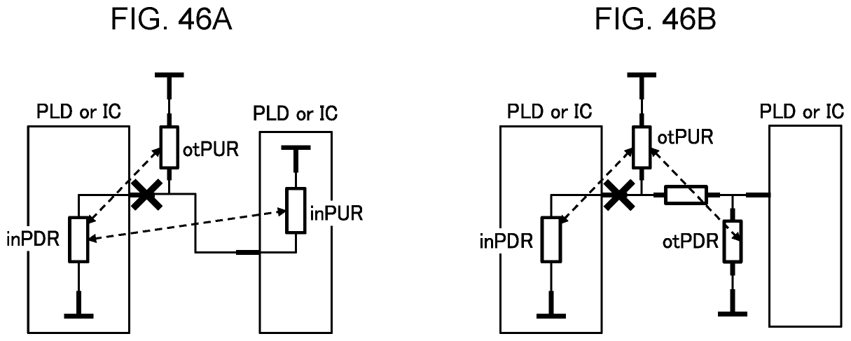

FIGS. 46A and 46B are diagrams illustrating an example of the mixed pattern including a plurality of errors classified into an error type D. FIG. 46A illustrates a pattern in which the internal pull-down resistor inPDR of the output pin and of the external pull-up resistor otPUR, the internal pull-up resistor inPUR of the input pin are mixed in a certain path.

In the mixed pattern of FIG. 46A, the error type C due to a mix of the internal pull-down resistor inPDR of the output pin and the external pull-up resistor otPUR is detected. The error type B due to the mix of the internal pull-down resistor inPDR of the output pin and the internal pull-up resistor inPUR of the input pin is detected as well. Therefore, it becomes a mixed pattern including a plurality of errors. In such a mixed pattern, one error icon 9b representing the error level “E” is displayed.

In addition, FIG. 46B illustrates a pattern in which the internal pull-down resistor inPDR of the output pin and of the external pull-up resistor otPUR, the external pull-down resistor otPDR are mixed in a certain path.

In the mixed pattern of FIG. 46B, the error type C due to a mix of the internal pull-down resistor inPDR of the output pin and the external pull-up resistor otPUR is detected. The error type A due to the mix of the external pull-up resistor otPUR and the external pull-down resistor otPDR is detected as well. Therefore, it becomes a mixed pattern including a plurality of errors. In such a mixed pattern, one error icon 9b representing the error level “E” is displayed.

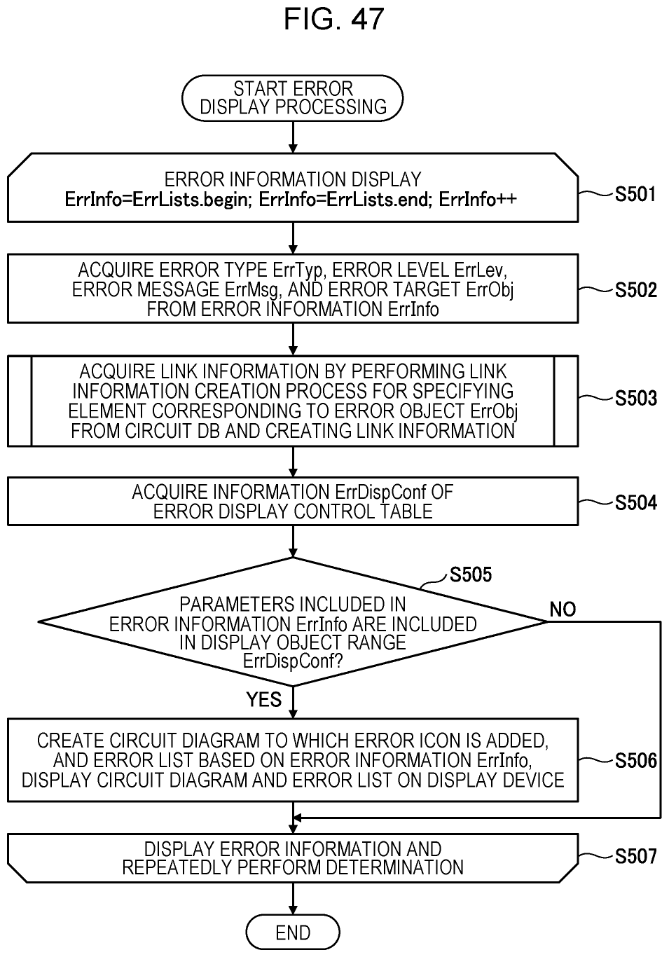

Next, the error display process by the display processing unit 48 will be described in detail. FIG. 47 is a flowchart illustrating an error display process by a display processing unit. In the error display process of FIG. 47, a list of error information obtained from the DRC definition table 51a and the DRC error information table 51b is referred to as an error list. In the error list, for each error information ID, an error type, an error level, an error message, an error object as an error element, and the like are indicated.

In FIG. 47, variables are defined as follows. ⋅ErrLists is an error list that lists one or more error pieces of information (ErrInfo). ⋅ErrLists.begin designates the first error information (1 record) in the error list (ErrLists). ⋅ErrLists.end designates the end error information (1 record) in the error list (ErrLists). ⋅As ErrInfo, display object error information is read and set in order from the error list (ErrLists). ErrInfo has a structure as an example, and has elements such as ErrTyp, ErrLev, ErrMsg, ErrObj, and ErrDispConf. ⋅ErrTyp is an error type in the error information (ErrInfo). ⋅ErrLev is an error level in the error information (ErrInfo). ⋅ErrMsg is an error message in the error information (ErrInfo). ⋅ErrObj is an error object in the error information (ErrInfo). ⋅ErrDispConf is information of the DRC error display control table 51d, and designates a display object range such as an error level and an error type to be displayed. Of these elements of the error information ErrInfo, the error type ErrTyp, the error level ErrLev, and the like are referred to as parameters.

The display processing unit 48 performs an initial setting to set the first error information of the error list (ErrLists) as ErrInfo, and updates the ErrInfo with the next error information in order from the error list (ErrLists) each time the error information display is repeated (operation S501).

The display processing unit 48 acquires the error type ErrTyp, the error level ErrLev, the error message ErrMsg, and the error object ErrObj from the error information ErrInfo (operation S502).

The display processing unit 48 acquires link information by performing a link information creation process for specifying the element corresponding to the error object ErrObj from the circuit DB and creating link information (operation S503), and acquires the information ErrDispConf of the DRC error display control table 51d (operation S504).

Subsequently, the display processing unit 48 determines whether or not the parameters (error type ErrTyp, error level ErrLev, and the like) included in the error information ErrInfo are included in the display object range ErrDispConf (operation S505). In a case where the parameters are not included in the display object range ErrDispConf (NO in operation S505), the display processing unit 48 proceeds to an operation S506.

On the other hand, the display processing unit 48 creates a circuit diagram to which an error icon is added and an error list based on the error information ErrInfo, displays the circuit diagram and error list on the display device 15 (operation S506), and proceeds to operation S506.

The display processing unit 48 repeatedly performs the determination (operation S507). It may be determined whether or not the error information ErrInfo is the end error information in the error list (ErrLists). In a case where the error information ErrInfo is not the end error information, the display processing unit 48 returns to the operation S501, acquires the next error information from the error list (ErrLists), updates the ErrInfo, and repeats the same process as described above. On the other hand, in a case where the error information ErrInfo is the end error information, the display processing unit 48 ends the error display process.

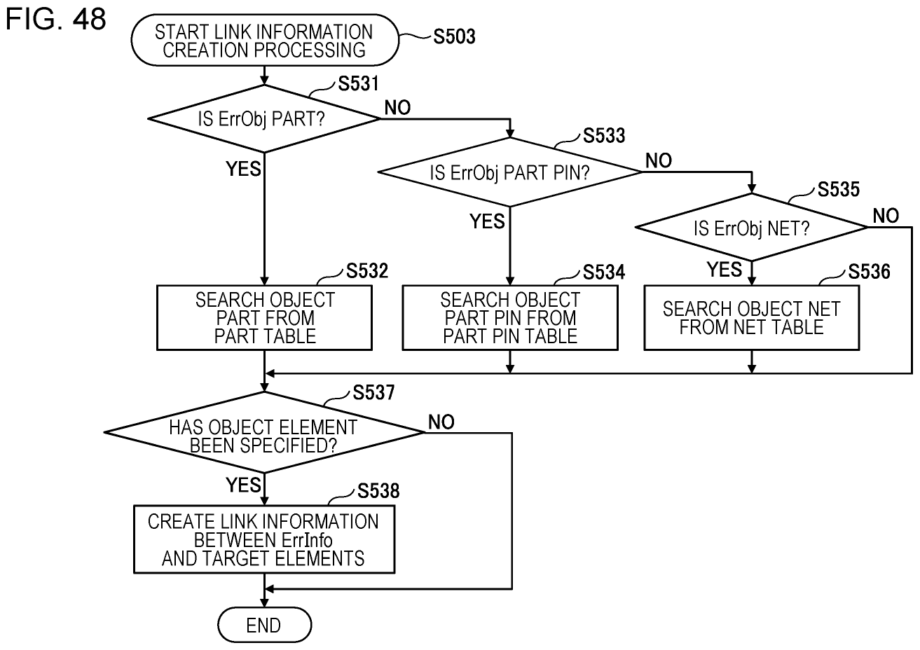

FIG. 48 is a flowchart for illustrating a link information creation process performed in operation S503 of FIG. 47. In FIG. 48, the display processing unit 48 determines whether or not the error object ErrObj is a part (operation S531). In a case where the error object ErrObj is a part (YES in operation S531), the display processing unit 48 searches for the object part from the part table 52b (operation S532), and proceeds to an operation S537.

On the other hand, in a case where the error object ErrObj is not a part (NO in operation S531), the display processing unit 48 determines whether or not the error object ErrObj is a part pin (operation S533). In a case where the error object ErrObj is a part pin (YES in operation S533), the display processing unit 48 searches for the object part pin from the part pin table 52d (operation S534), and proceeds to the operation S537.

On the other hand, in a case where the error object ErrObj is not a part pin (NO in operation S533), the display processing unit 48 determines whether or not the error object ErrObj is a net (operation S535). In a case where the error object ErrObj is the net (YES in operation S535), the display processing unit 48 searches for the net from the part pin table 52d (operation S536), and proceeds to the operation S537. On the other hand, in a case where the error object ErrObj is not a net (NO in operation S535), the display processing unit 48 proceeds to the operation S537 without performing any table search.

The display processing unit 48 determines whether or not the object element that is in error has been specified (operation S537). In a case where the object element was not able to be specified (NO in operation S537), the display processing unit 48 creates link information between error information (ErrInfo) and the object elements (operation S538), and ends this link information creation process. The link information is stored in the storage unit 130.

As described above, in this embodiment, the verification process is performed in consideration of the internal resistor (pull-up resistor or pull-down resistor) of the PLD and IC that are integrated circuits. Based on the result of the verification process, it is possible to display an error icon and a list of error contents that may identify a path where an error exists.

By displaying the error detected in consideration of the pull-up resistor or pull-down resistor inside the integrated circuit relating to the path, the user may quickly reviews the design deficiency at the circuit design stage relating to the printed circuit board (PCB).

In this embodiment, a function of verifying whether or not the pull-up resistor and the pull-down resistor in addition to the internal resistor of the processor are correctly used for a given circuit diagram may be provided as one of design rule checks (DRC).

In this embodiment, the verification process (FIGS. 31 to 36) performed by the DRC processing unit 43 corresponds to an example of the verification unit, the error display process (FIGS. 47 and 48) performed by the display processing unit 48 corresponds to an example of an error output unit. The PLD is a programmable integrated circuit in terms of the characteristics thereof, and the IC is an integrated circuit having a fixed logic circuit configuration in comparison with the PLD.

The disclosure is not limited to the specifically disclosed embodiment, and various modifications and variations are possible without departing from the scope of the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable non-transitory recording medium having stored therein a pull-up and pull-down resistor verification program that causes a computer to execute a procedure, the procedure comprising:
reading first definition information to define that a first resistor of a first circuit is a pull-up resistor or a pull-down resistor and second definition information to define that a second resistor of a second circuit is a pull-up resistor or a pull-down resistor;
comparing the first definition information and the second definition information; and
generating an error message in a case where one of the first resistor and the second resistor is the pull-up resistor and the other one is the pull-down resistor.

2. The computer-readable non-transitory recording medium according to claim 1,
wherein one or both of the first resistor and the second resistor are an internal resistor of a programmable integrated circuit.

3. The computer-readable non-transitory recording medium according to claim 1,
wherein one or both of the first resistor and the second resistor are an external resistor coupled to a path between a first programmable integrated circuit and a second programmable integrated circuit.

4. The computer-readable non-transitory recording medium according to claim 1,
wherein one or both of the first resistor and the second resistor are an external resistor coupled to a path between a programmable integrated circuit and an integrated circuit that has a fixed logic circuit configuration.

5. The computer-readable non-transitory recording medium according to claim 2, further comprising:
displaying a circuit diagram that includes the first circuit and the second circuit by adding first error information over a path coupling the first circuit and the second circuit to the circuit diagram when one or both of the first resistor and the second resistor is detected to be the internal resistor of a programmable integrated circuit.

6. The computer-readable non-transitory recording medium according to claim 3, further comprising:
displaying a circuit diagram that includes the first circuit and the second circuit by adding first error information over a path coupling the first circuit and the second circuit to the circuit diagram when one of the first resistor and the second resistor is detected to be the external resistor and the other one is the internal resistor.

7. The computer-readable non-transitory recording medium according to claim 3, further comprising:
displaying a circuit diagram that includes the first circuit and the second circuit by adding second error information over a path coupling the first circuit and the second circuit to the circuit diagram when both of the first resistor and the second resistor are detected to be the external resistors.

8. The computer-readable non-transitory recording medium according to claim 5,
wherein the procedure generates the error message linked to the first error information.

9. The computer-readable non-transitory recording medium according to claim 7,
wherein the procedure generates the error message linked to the second error information.

10. The computer-readable non-transitory recording medium according to claim 1, further comprising:
displaying that first error information for indicating that one or both of the first resistor and the second resistor is detected to be an internal resistor, has a higher error level than second error information for indicating that both of the first resistor and the second resistor are detected to be external resistors, over a circuit diagram to be visible by highlighting.

11. A pull-up and pull-down resistor verification method comprising:
reading first definition information to define that a first resistor of a first circuit is a pull-up resistor or a pull-down resistor and second definition information to define that a second resistor of a second circuit is a pull-up resistor or a pull-down resistor;
comparing the first definition information and the second definition information; and
generating an error message in a case where one of the first resistor and the second resistor is the pull-up resistor and the other one is the pull-down resistor, by a processor.

12. An information processing apparatus comprising:
a memory; and
a processor coupled to the memory and configured to:
read, from the memory, first definition information to define that a first resistor of a first circuit is a pull-up resistor or a pull-down resistor and second definition information to define that a second resistor of a second circuit is a pull-up resistor or a pull-down resistor,
compare the first definition information and the second definition information with each other, and
generate an error message in a case where one of the first resistor and the second resistor is the pull-up resistor and the other one is the pull-down resistor.
